(19) United States
(12) Patent Application Publication
(10) Pub. No.: US 2018/0117987 A1
(43) Pub. Date: May 3, 2018

(54) AIR CONDITIONING UNIT FOR VEHICLE SEAT

(71) Applicant: DENSO CORPORATION, Kariya-city, Aichi-pref. (JP)

(72) Inventors: Jun YAMAOKA, Kariya-city (JP); Takahito NAKAMURA, Kariya-city (JP)

(73) Assignee: DENSO CORPORATION, Kariya-city, Aichi-pref. (JP)

(21) Appl. No.: 15/561,278

(22) PCT Filed: Mar. 17, 2016
(86) PCT No.: PCT/JP2016/058596

§ 371 Date: Sep. 25, 2017

(30) Foreign Application Priority Data
Apr. 2, 2015 (JP) 2015-076157

(51) Int. Cl. B60H 1/00

(52) U.S. Cl. CPC B60H 1/00285; B60H 1/00564; A47C 7/74; B60H 1/00821; B60H 1/00485

(57) ABSTRACT

A plurality of seating surface blowing ports is open at a seating surface of a seat. A first rear seat blowing port is provided on a rear side of the seat and opens toward a rear seat on the rear side of the seat. A single first duct is provided between the plurality of seating surface blowing ports, the first rear seat blowing port and the interior air conditioning unit, and guides the air conditioning wind from the interior air conditioning unit to the plurality of seating surface blowing ports and the first rear seat blowing port. The air conditioning wind that flows from the interior air conditioning unit through the first duct is blown out into a vehicle interior from the plurality of seating surface blowing ports and the first rear seat blowing port.

### CROSS REFERENCE TO RELATED APPLICATION

This application is based on Japanese Patent Application No. 2015-76157 filed on Apr. 2, 2015, the disclosure of which is incorporated herein by reference.

### TECHNICAL FIELD

The present disclosure relates to an air conditioning unit for a vehicle seat.

### BACKGROUND ART

Conventionally, a vehicle seat air conditioning unit is installed in a seat, the vehicle seat air conditioning unit including multiple blowing ports (hereinafter referred to as seating surface blowing ports) which open in a seating surface of the seat, and a temperature adjusting unit for regulating a temperature of an air conditioning wind, which is blown out from each of the multiple seating surface blowing ports.

However, there is no room for mounting the temperature adjusting unit in an actual seat, and therefore, it is difficult to install the temperature adjusting unit in the seat. Even in a case where a temperature adjusting unit is mounted in the seat, downsizing is required to the temperature adjusting unit, and it is difficult to secure a sufficient cooling and heating capacity.

Under the circumstance, Patent Literature 1 proposes a device for guiding air conditioning wind, which is blown from an interior air conditioning unit provided in an instrument panel in a front portion of a vehicle interior through a first duct to a plurality of seating surface blowing ports of a front seat, and for blowing out the air conditioning wind from a plurality of seating surface blowing ports.

The device has a rear seat blowing port, which is provided in the vicinity of an armrest on a center side in a vehicle width direction of the front seat in the vehicle interior and opens toward a rear seat. The device further includes a second duct, which is provided independently from a first duct and guides the air conditioning wind, which is blown out from a vehicle interior air conditioning unit to the rear seat blowing port.

Because of the configuration, the air conditioning wind flowing from the vehicle interior air conditioning unit through the first duct is blown out from the multiple seating surface blowing ports of the front seat, and the air conditioning wind flowing from the vehicle interior air conditioning unit through the second duct can be discharged from the rear seat blowing port toward an occupant on the rear seat.

### PRIOR ART LITERATURES

### Patent Literature

Patent Literature 1: US Patent Application Publication No. 2010/0314071

### SUMMARY OF INVENTION

In the vehicle seat air conditioning unit disclosed in Patent Literature 1, as described above, because the rear seat blowing port is provided in the vicinity of the armrest on the center side in the vehicle width direction of the front seat, a distance between the rear seat blowing port and the occupant on the rear seat is increased. Therefore, a sufficient air volume could not be delivered from the rear seat blowing port to the occupant on the rear seat. For that reason, the occupant on the rear seat cannot be given high comfort due to the air conditioning wind, which is blown out from the rear seat blowing port.

The present disclosure has been made in view of the above circumstance, and it is an object of the present disclosure to improve the comfort of an occupant on a rear seat in a vehicle seat air conditioning unit that blows air conditioning wind from multiple seating surface blowing ports.

According to an aspect of the present disclosure, a vehicle seat air conditioning unit is for use in an automobile having an interior air conditioning unit provided outside of a seat in a vehicle interior to blow an air conditioning wind. The vehicle seat air conditioning unit comprises:

a plurality of seating surface blowing ports opening in a seating surface of the seat on which an occupant is seated;

a first rear seat blowing port provided on a rear side of the seat in a vehicle traveling direction and opens toward a rear seat, which is provided on the rear side of the seat in the vehicle traveling direction; and

a single first duct provided between the plurality of seating surface blowing ports, the first rear seat blowing port and the interior air conditioning unit, and guides the air conditioning wind from the interior air conditioning unit to the plurality of seating surface blowing ports and the first rear seat blowing port, wherein

the plurality of seating surface blowing ports and the first rear seat blowing port blow out the air conditioning wind, which flows from the interior air conditioning unit through the first duct, into a vehicle interior.

According to this aspect, since the first rear seat blowing port is provided in the seat on the rear side in the vehicle traveling direction, a distance between the first rear seat blowing port and the occupant on the rear seat can be shortened. Therefore, the volume of air delivered from the first rear seat blowing port to the occupant on the rear seat can be increased. Therefore, the comfort of the occupant on the rear seat can be improved.

In addition, a single first duct is used to guide the air conditioning wind, which is blown from the vehicle interior air conditioning unit to the multiple seating surface blowing ports and the first rear seat blowing port. For that reason, as compared to a case where two first ducts are used to guide the air conditioning wind, which is blown from the vehicle interior air conditioning unit to the multiple seating surface blowing ports and the first rear seat blowing port, the mountability of the vehicle seat air conditioning unit on the automobile can be improved.

It is noted that, the seating surface is a portion that supports the thigh, buttocks, and back of the occupant in the seat.

### BRIEF DESCRIPTION OF THE DRAWINGS

FIG. 1 is a diagram illustrating a schematic configuration of a vehicle air conditioning apparatus according to a first embodiment.

FIG. 2 is a diagram illustrating a configuration of a valve in FIG. 1.

FIG. 3 is a diagram illustrating an internal structure of a front seat in FIG. 1.

FIG. 4 is a diagram illustrating an electric configuration of the vehicle air conditioning apparatus in FIG. 1.

FIG. 5 is a flowchart illustrating a control process of an electronic control device in FIG. 4.

FIG. 6 is a diagram illustrating a schematic configuration of a vehicle air conditioning apparatus according to a first modification of the first embodiment.

FIG. 7 is a diagram illustrating a schematic configuration of a vehicle air conditioning apparatus according to a second modification of the first embodiment.

FIG. 8 is a diagram illustrating a schematic configuration of a vehicle air conditioning apparatus according to a third modification of the first embodiment.

FIG. 9 is a diagram illustrating a schematic configuration of a vehicle air conditioning apparatus according to a fourth modification of the first embodiment.

FIG. 10 is a diagram illustrating a schematic configuration of a vehicle air conditioning apparatus according to a fifth modification of the first embodiment.

FIG. 11 is a diagram illustrating a schematic configuration of a vehicle air conditioning apparatus according to a second embodiment.

FIG. 12 is a diagram illustrating an electric configuration of the vehicle air conditioning apparatus in FIG. 11.

FIG. 13 is a flowchart illustrating a control process of an electronic control device in FIG. 12.

FIG. 14 is a diagram illustrating a schematic configuration of a vehicle air conditioning apparatus according to a third embodiment.

FIG. 15 is a diagram illustrating a schematic configuration of a vehicle air conditioning apparatus according to a fourth embodiment.

FIG. 16 is a vertical cross-sectional view of a vicinity of a rear seat face blowing port.

FIG. 17 is a cross-sectional view taken along a line XVII-XVII in FIG. 16.

FIG. 18 is a vertical cross-sectional view of a vicinity of a rear seat face blowing port.

FIG. 19 is a vertical cross-sectional view of a vicinity of a rear seat face blowing port.

FIG. 20 is a vertical cross-sectional view of a vicinity of a rear seat face blowing port according to a fifth embodiment.

FIG. 21 is a vertical cross-sectional view of a vicinity of a rear seat face blowing port according to a sixth embodiment.

FIG. 22 is a vertical cross-sectional view of a vicinity of a rear seat face blowing port according to a seventh embodiment.

FIG. 23 is a cross-sectional view taken along a line XXIII-XXIII in FIG. 22.

FIG. 24 is a cross-sectional view illustrating a case in which an air current is expanded in a vehicle width direction.

FIG. 25 is a cross-sectional view illustrating a case in which the air current is narrowed in the vehicle width direction.

FIG. 26 is a horizontal cross-sectional view of a vicinity of a rear seat face blowing port according to an eighth embodiment.

### DESCRIPTION OF EMBODIMENTS

Embodiments will be described with reference to the drawings below. In the respective embodiments to be described below, for the purpose of simplifying the description, the same reference signs will be assigned to the similar or the equivalent portions in the drawings.

### First Embodiment

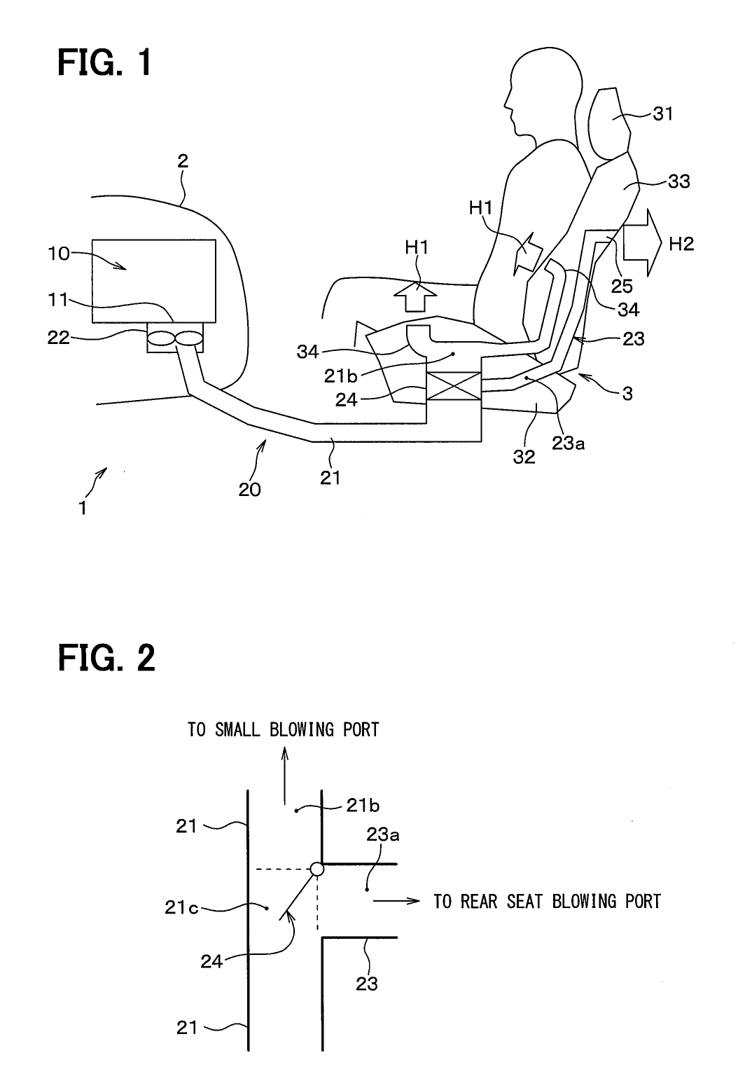

FIG. 1 illustrates a configuration of a vehicle air conditioning apparatus 1 according to a first embodiment. FIG. 1 is a diagram illustrating a layout of the vehicle air conditioning apparatus 1 in a vehicle interior.

The vehicle air conditioning apparatus 1 includes an interior air conditioning unit 10 illustrated in FIG. 1. The interior air conditioning unit 10 is provided inside of a dashboard panel (instrument panel) 2 on a foremost portion of the vehicle interior.

The interior air conditioning unit 10 is a known unit that includes an air blowing unit and a heater unit and blows an air conditioning wind from multiple blowing opening portions. Specifically, the air blowing unit introduces a vehicle interior air or a vehicle exterior air to blow out the air. The heater unit includes a cooling heat exchanger, a heating heat exchanger, an air mixing door, and the like, and regulates a temperature of the air flow blown out from the air blowing unit and blows out the regulated air as an air conditioning wind from the multiple blowing opening portions.

In this example, the multiple blowout openings include a face blowing opening portion, a foot blowing opening portion, a defroster blowing opening portion, and a seat air conditioning blowing opening portion 11.

The face blowing opening portion blows out the air conditioning wind to the face blowing port through a face duct. The face blowing port blows out the air conditioning wind to an upper body of an occupant on a front seat.

The foot blowing opening portion blows out the air conditioning wind to the foot blowing port through a foot duct. The foot blowing port blows out the air conditioning wind to a lower body of the occupant on the front seat.

The defroster blowing opening portion blows the air conditioning wind through a defroster duct to a defroster blowing port. The defroster blowing port blows the air conditioning wind to an inner surface of a front windshield.

The face blowing port, the foot blowing port, and the defroster blowing port according to the present embodiment air-condition a front side of the vehicle interior in a vehicle traveling direction according to the air conditioning wind, which is blown out from the respective blowing ports. The face blowing port, the foot blowing port, and the defroster blowing port are each provided in an instrument panel.

As will be described later, the seat air conditioning blowing opening portion 11 blows out the air conditioning wind toward multiple seating surface blowing ports and a rear seat face blowing port 25 of the front seat. The rear seat face blowing port 25 corresponds to a first rear seat blowing port.

The vehicle air conditioning apparatus 1 includes a seat air conditioning unit 20 illustrated in FIG. 1. The seat air conditioning unit 20 blows out the air conditioning wind from the multiple seating surface blowing ports on the seating surface of the front seat 3 and blows out the conditioned air from the rear seat face blowing port 25 in a back surface of the front seat 3.

The seat air conditioning unit 20 includes a single seat air conditioning duct 21, a sub-fan 22, a back duct 23, a valve 24, and a rear seat face blowing port 25. The seat air conditioning duct 21 corresponds to the first duct.

The seat air conditioning duct 21 is provided between the multiple seating surface blowing ports, the rear seat face blowing port 25, and the seat air conditioning blowing opening portion 11 of the interior air conditioning unit 10. The seat air conditioning duct 21 is formed so as to extend from an inside of the instrument panel 2 toward the front seat 3 and is coupled to the front seat 3. The seat air conditioning duct 21 guides the air conditioning wind, which is blown out from the seat air conditioning blowing opening portion 11 to the multiple seating surface blowing ports and the rear seat face blowing port 25. The seat air conditioning duct 21 is a single duct provided on a floor side in the vehicle interior.

The sub-fan 22 is provided between the seat air conditioning blowing opening portion 11 and an air inlet of the seat air conditioning duct 21. The sub-fan 22 is configured with an electric fan and backs up the air conditioning wind, which is blown out from the seat air conditioning blowing opening portion 11 to guide the air conditioning wind to the multiple seating surface blowing ports and the rear seat face blowing port 25. The sub-fan 22 according to the present embodiment is provided inside of the instrument panel 2.

As illustrated in FIG. 2, an air inlet of the back duct 23 is connected to a portion 21c of the seat air conditioning duct 21 between an air inlet and an air outlet of the seat air conditioning duct 21. An air outlet of the back duct 23 is connected to the rear seat face blowing port 25. The back duct 23 is provided in a seat cushion 32 and a seat back 33 of the front seat 3.

The back duct 23 defines a back air passage 23a for guiding a part of the air conditioning wind in the air flow flowing from the sub-fan 22 through the seat air conditioning duct 21 to the rear seat face blowing port 25.

Because of the configuration, among the air flows flowing from the sub-fan 22 through the seat air conditioning duct 21, a remaining air flow other than the air flow flowing into the rear seat face blowing port 25 flows through the seating surface air passage 21b into the multiple seating surface blowing ports. The seating surface air passage 21b is an air passage on the side of the multiple seating surface blowing ports with respect to the portion 21c of the seat air conditioning duct 21 to which the air inlet of the back duct 23 is connected.

The valve 24 is provided in the portion 21c of the seat air conditioning duct 21. The valve 24 includes a valve body for regulating a ratio of an opening area of the back air passage 23a to an opening area of the seating surface air passage 21b and an electric actuator that operates the valve body. For that reason, the valve 24 regulates a ratio of the volume of air, which flows into the multiple seating surface blowing ports, to the volume of air, which flows into the rear seat face blowing port 25, among the air flow flowing from the sub-fan 22 through the seat air conditioning duct 21. The valve 24 according to the present embodiment is provided in the seat cushion 32 of the front seat 3. The valve 24 corresponds to a first air volume adjusting valve.

The rear seat face blowing port 25 is provided on the back side of the front seat 3 (that is, on the rear side in the vehicle traveling direction) and opens toward the rear seat (that is, toward the rear in the vehicle traveling direction). Specifically, the rear seat face blowing port 25 configures a face blowing port for blowing the air conditioning wind to the upper body of the occupant on the rear seat from a front surface. The rear seat is located on the rear side of the front seat 3 in the vehicle interior in the vehicle traveling direction.

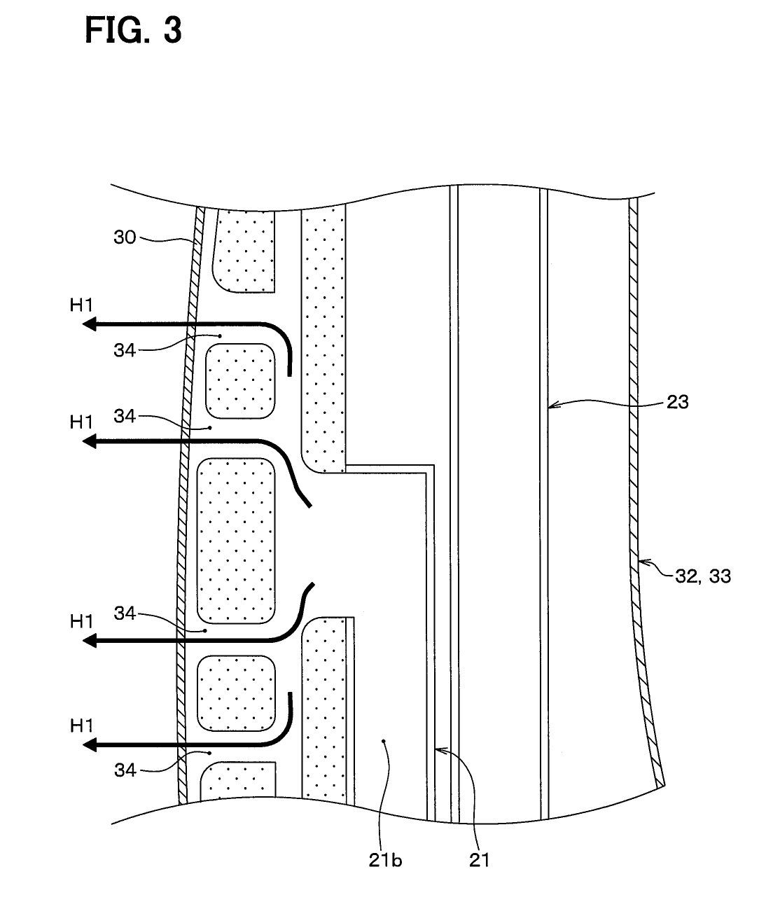

The front seat 3 according to the present embodiment includes a seat skin 30, a headrest 31, the seat cushion 32, and the seat back 33 illustrated in FIG. 3.

The seat skin 30 is formed of a seat (for example, a nonwoven fabric or a real leather) having multiple seating surface blowing ports. The seating surface blowing ports are configured with minute holes defined in the seat skin 30. The seat skin 30 is formed so as to cover the seat cushion 32 and the seat back 33. A portion of the seat skin 30 covering the seat cushion 32 and the seat back 33 configures a seating surface on which the occupant is seated. In other words, the seating surface configures a portion of the seat which supports a thigh, buttocks, and a back of the occupant.

The headrest 31, the seat cushion 32, and the seat back 33 are supported by a seat frame, which is not shown. The headrest 31 supports a head of the occupant. The seat cushion 32 supports the thighs and the buttocks of the occupant. The seat back 33 supports the back of the occupant.

The seat cushion 32 and the seat back 33 are made of urethane resin or the like. As illustrated in FIG. 3, the seat cushion 32 and the seat back 33 are provided with a plurality of air flow passages 34 opened to the seat skin 30 on the occupant side.

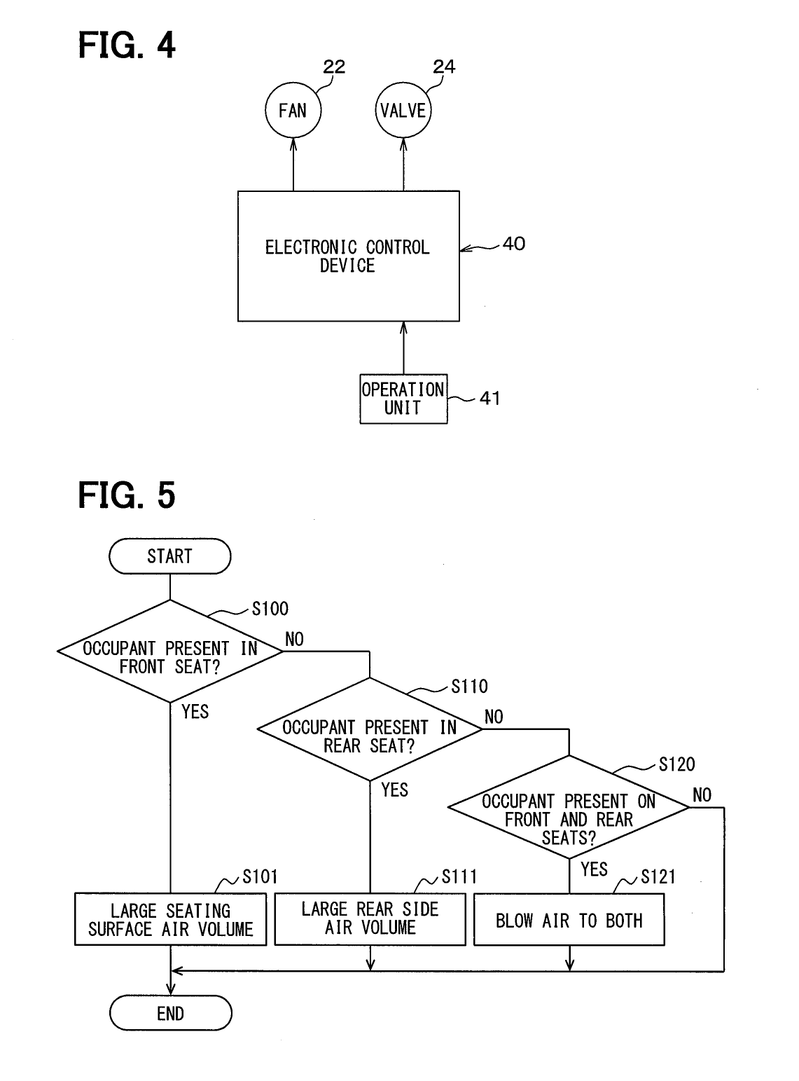

Subsequently, an electric configuration of the seat air conditioning unit 20 according to the present embodiment will be described with reference to FIG. 4.

The seat air conditioning unit 20 includes an electronic control device 40. The electronic control device 40 includes a microcomputer, a memory device, and the like, and executes a seat air conditioning control process.

The electronic control device 40 controls the sub-fan 22 and the valve 24 based on an output signal of the operation unit 41 when executing the seat air conditioning control process. The operation unit 41 is operated by the occupant to set a blowing port from which the air conditioning wind is to be blown out in the multiple seating surface blowing ports and the rear seat face blowing port 25.

Subsequently, the operation of the seat air conditioning unit 20 according to the present embodiment will be described with reference to FIG. 5.

FIG. 5 is a flowchart illustrating the seat air conditioning control process. The electronic control device 40 executes a computer program according to a flowchart illustrated in FIG. 5.

For example, when the occupant is present on the front seat 3 and no occupant is present on the rear seat, the occupant operates the operation unit 41 to give an instruction on mainly blowing out the air conditioning wind from the multiple seating surface blowing ports in the multiple seating surface blowing ports and the rear seat face blowing port 25.

In association with the above processing, the electronic control device 40 determines whether the occupant is present on the front seat 3 between the front seat 3 and the rear seat based on the output signal from the operation unit 41 (yes in Step S100). In this situation, in Step S101, the electronic control device 40 controls the valve 24 to open the seating surface air passage 21b and close the back air passage 23a.

For that reason, in the air flow flowing from the sub-fan 22 through the seat air conditioning duct 21, the volume of air flowing into the multiple seating surface blowing ports is increased more than the volume of air flowing into the rear seat face blowing port 25 by the adjustment of the valve 24.

In that case, most of the air flow that flows from the seat air conditioning blowing opening portion 11 of the interior air conditioning unit 10 through the sub-fan 22 and the seat air conditioning duct 21 flows into the multiple air flow passages 34 in the seat cushion 32 and the seat back 33 of the front seat 3. Along with the above air flow, the air is blown out from the multiple air flow passages 34 toward the occupant (that is, toward the vehicle interior side) through the multiple seating surface blowing ports of the seat skin 30 (that is, the seating surface).

On the other hand, the air flow flowing from the seat air conditioning blowing opening portion 11 of the interior air conditioning unit 10 through the sub-fan 22 and the seat air conditioning duct 21 will be described. In the above air flow, the remaining air conditioning wind besides most of the air conditioning wind described above is blown out through the back duct 23 from the rear seat face blowing port 25 toward a position corresponding to the upper body of the rear seat. The position corresponding to the upper body of the rear seat means a position corresponding to the upper body of the occupant when the occupant is seated on the rear seat.

In addition, when the occupant is not present on the front seat 3 and the occupant is present on the rear seat, the occupant operates the operation unit 41 to give an instruction on mainly blowing out the air conditioning wind from the rear seat face blowing port 25 in the multiple seating surface blowing ports and the rear seat face blowing port 25.

In association with the above processing, the electronic control device 40 determines whether the occupant is present on the rear seat among the front seat 3 and the rear seat based on the output signal from the operation unit 41 (no in Step S100 and yes in Step S110).

In this situation, in Step S111, the electronic control device 40 controls the valve 24 to close the seating surface air passage 21b and open the back air passage 23a. For that reason, in the air flow flowing from the sub-fan 22 through the seat air conditioning duct 21, the volume of air flowing into the rear seat face blowing port 25 is increased more than the volume of air flowing into the multiple seating surface blowing ports.

In this case, the air conditioning wind that flows from the seat air conditioning blowing opening portion 11 of the interior air conditioning unit 10 through the sub-fan 22, the seat air conditioning duct 21, and the back duct 23 will be described. Most of the air conditioning wind in this air conditioning wind is blown out from the rear seat face blowing port 25 toward the upper body of the occupant on the rear seat.

On the other hand, the air flow flowing from the seat air conditioning blowing opening portion 11 of the interior air conditioning unit 10 through the sub-fan 22 and the seat air conditioning duct 21 will be described. The remaining air conditioning wind other than most of the conditioned air described above in the air flow is blown out into the vehicle interior through the multiple air flow passages 34 in the seat cushion 32 and the seat back 33 of the front seat 3 and the multiple seating surface blowing ports in the seat skin 30.

Further, when the occupant is present on the front seat 3 and the occupant is present on the rear seat, the occupant operates the operation unit 41 to give an instruction on setting the air conditioning wind, which is blown out from the multiple seating surface blowing ports to be equal to the conditioned air blown out from the rear seat face blowing port 25.

In association with the above processing, the electronic control device 40 determines whether the occupants are present on the front seat 3 and the rear seat, respectively, based on the output signal from the operation unit 41 (no in Step S110 and yes in Step S120).

In this situation, in Step S121, the electronic control device 40 controls the valve 24 to open the seating surface air passage 21b and the back air passage 23a. For that reason, half of the air conditioning wind flowing from the seat air conditioning blowing opening portion 11 of the interior air conditioning unit 10 through the sub-fan 22 and the seat air conditioning duct 21 is blown out toward the occupant through the multiple air flow passages 34 and the multiple seating surface blowing ports.

On the other hand, the air conditioning wind flowing from the seat air conditioning blowing opening portion 11 of the interior air conditioning unit 10 through the sub-fan 22 and the seat air conditioning duct 21 will be described. The remaining half air conditioning wind of this air conditioning wind is blown out from the rear seat face blowing port 25 toward the upper body of the occupant on the rear seat through the back duct 23.

According to the present embodiment described above, the vehicle seat air conditioning unit 20 is applied to a vehicle having the interior air conditioning unit 10, the seating surface blowing ports, and the rear seat face blowing port 25. The interior air conditioning unit 10 is provided at a portion outside the seat in the vehicle interior to blow out the air conditioning wind. The seating surface blowing ports are opened in the seating surface of the front seat 3. The rear seat face blowing port 25 is provided on the back surface of the front seat 3 and opened toward the rear seat provided at the rear portion relative to the front seat 3 in the vehicle traveling direction. The vehicle seat air conditioning unit 20 includes a single seat air conditioning duct 21 that is provided between the multiple seating surface blowing ports as well as the rear seat face blowing port 25 and the interior air conditioning unit 10. The air conditioning wind that flows from the seat air conditioning blowing opening portion 11 of the interior air conditioning unit 10 through the seat air conditioning duct 21 is blown out from the multiple minute seating surface blowing ports and the rear seat face blowing port 25 into the vehicle interior.

Therefore, the seat air conditioning duct 21 is installed between the interior air conditioning unit 10 and the front seat 3, and the air conditioning wind of the interior air conditioning unit 10 is blown out to the front seat 3. Because of the configuration, the temperature adjustment unit may not be mounted on the front seat 3 and the mountability in the front seat 3 can be improved.

In the present embodiment, the single seat air conditioning duct 21 is used to guide the air conditioning wind, which is blown out from the interior air conditioning unit 10 to the multiple seating surface blowing ports and the rear seat face blowing port 25. For that reason, as compared to a configuration where two ducts are used to guide the air conditioning wind, which is blown out from the interior air conditioning unit 10 to the multiple seating surface blowing ports and the rear seat face blowing port 25, the vehicle seat air conditioning unit 20 can be easily mounted on the automobile. In other words, the mountability of the vehicle seat air conditioning unit 20 on the automobile can be improved.

In general, because the interior of the front seat 3 contains a large number of objects such as a driving motor for a movable portion such as reclining and an air-bag, and a size of the front seat 3 is related to an occupant's living space, the front seat 3 is desired to be reduced in size as much as possible. The present embodiment having no temperature adjustment unit in the front seat 3 is an effective countermeasure against such a demand.

In addition, in the case where the temperature adjusting unit is provided in a limited space of the front seat 3, because there is a limit to the size of the temperature adjustment unit, the cooling and heating ability of the air conditioning is also limited. To the contrary, in the present embodiment, with the use of the air conditioning wind of the interior air conditioning unit 10, the cooling and heating ability larger than the temperature adjustment unit mounted on the front seat 3 is accomplished.

In the present embodiment, as described above, the air conditioning wind is supplied from the rear seat face blowing port 25 on the rear side of the front seat 3 toward the rear seat. For that reason, as compared with a case in which the rear seat face blowing port 25 is provided in an armrest on a center side of the front seat in the vehicle width direction, a distance between the rear seat face blowing port 25 and the rear seat occupant is shortened. In addition, the air conditioning wind is supplied from the front side of the occupant on the rear seat to the occupant on the rear seat by the rear seat face blowing port 25, thereby being capable of improving a cooling and heating performance and the comfort for the occupant on the rear seat.

In the present embodiment, when the occupant is present on the front seat 3 and no occupant is present on the rear seat, in the air conditioning wind flowing from the sub-fan 22 through the seat air conditioning duct 21, the volume of air flowing into the multiple seating surface blowing ports is increased more than the volume of air flowing into the rear seat face blowing port 25 by the operation of the valve 24. For that reason, a cooling and heating ability by the air conditioning wind, which is blown out from the multiple seating surface blowing ports, can be improved.

On the other hand, a case in which no occupant is present on the front seat 3 and the occupant is present on the rear seat will be described. In this situation, in the air conditioning wind flowing from the sub-fan 22 through the seat air conditioning duct 21, the volume of air flowing into the rear seat face blowing port 25 is increased more than the volume of air flowing into the multiple seating surface blowing ports by the operation of the valve 24. Therefore, a cooling and heating ability by the air conditioning wind, which is blown out from the rear seat face blowing port 25, can be improved. Therefore, the cooling and heating ability that can be supplied to the occupant can be controlled according to whether the occupant is present in the vehicle interior, or not.

In the present embodiment, the sub-fan 22 can back up the air conditioning wind, which is blown out from the seat air conditioning blowing opening portion 11 to guide the air conditioning wind to the multiple seating surface blowing ports and the rear seat face blowing port 25. Therefore, ventilation resistances of the seat air conditioning duct 21, the multiple air flow passages 34, and the back duct 23 is larger than those of the face duct, the foot duct, and so on connected to the interior air conditioning unit 10. Even though, the air conditioning wind of the required air volume can be guided to the multiple seating surface blowing ports and the rear seat face blowing port 25.

In the above first embodiment, the sub-fan 22 is provided between the interior air conditioning unit 10 and the seat air conditioning duct 21. Instead, the sub-fan 22 may be provided in the following manners (1), (2-1), (2-2), and (3).

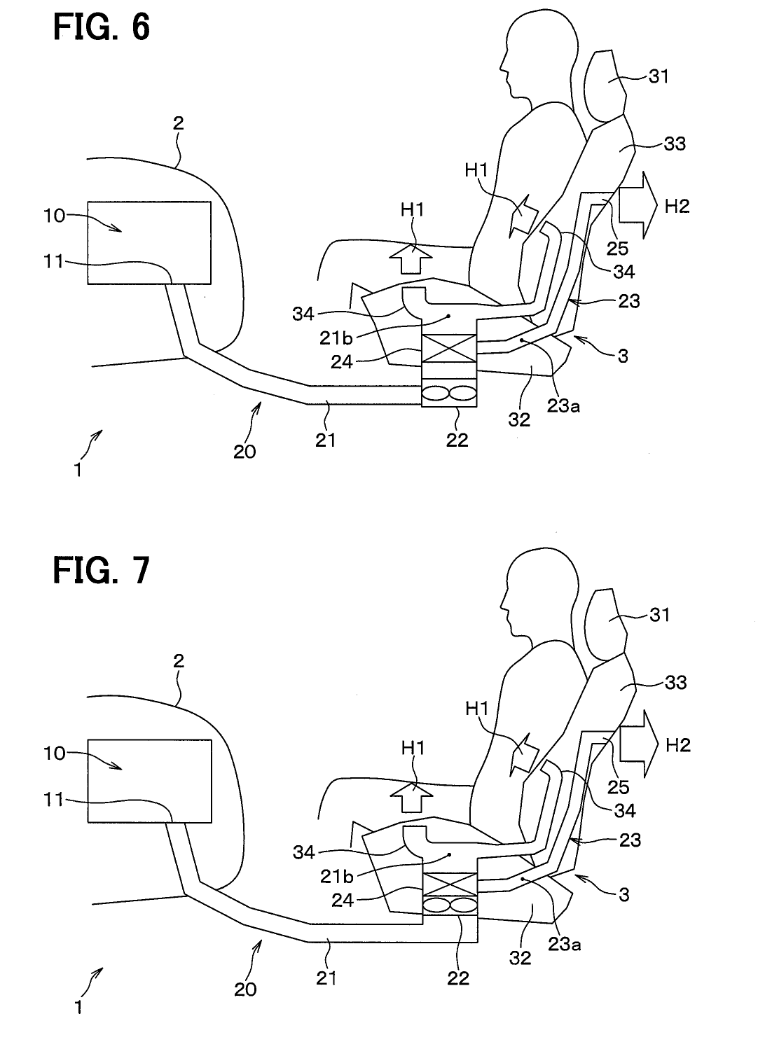

(1) As illustrated in FIG. 6, the sub-fan 22 is provided between the air inlet and the air outlet of the seat air conditioning duct 21.

(2-1) The sub-fan 22 is provided between the air outlet of the seat air conditioning duct 21 and the valve 24.

(2-2) As illustrated in FIG. 7, the sub-fan 22 is provided on a downstream side of the air inlet of the seat air conditioning duct 21 and upstream side of the valve 24 in the seat air conditioning duct 21. The sub-fan 22 is provided outside of the instrument panel 2. Further, the sub-fan 22 is provided in the seat cushion 32.

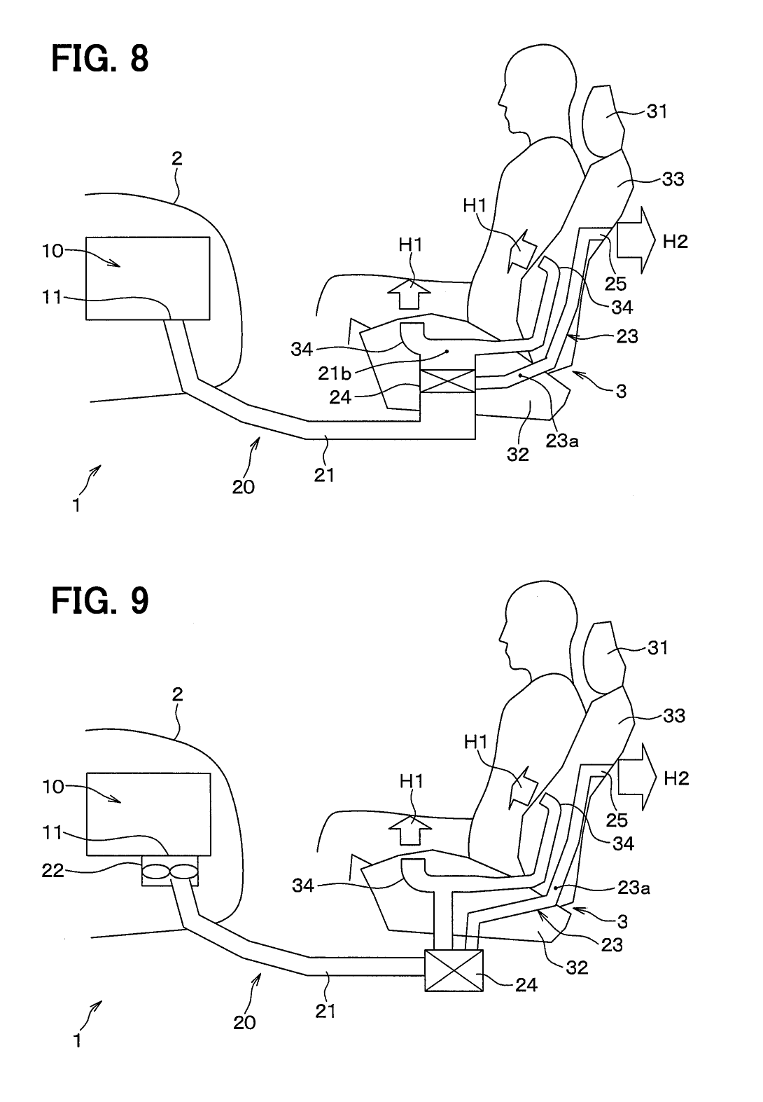

(3) As illustrated in FIG. 8, the sub-fan 22 is omitted.

In the above first embodiment, the example in which the valve 24 is provided inside of the front seat 3 is described. Instead, the valve 24 may be provided in the following manners (4) and (5).

(4) As illustrated in FIG. 9, the valve 24 is provided on a lower side of the front seat 3.

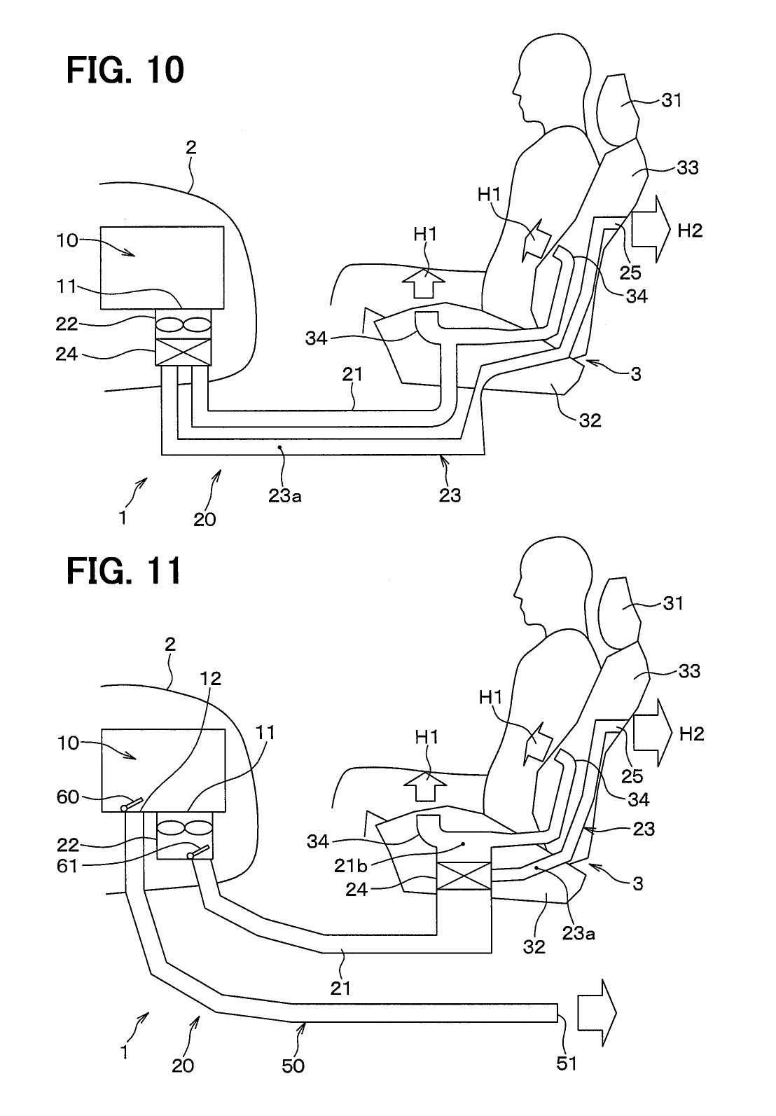

(5) As illustrated in FIG. 10, the valve 24 is provided between the sub-fan 22 and the air inlet of the seat air conditioning duct 21.

### Second Embodiment

In a second embodiment, an example in which a rear seat foot duct 50 is added to the seat air conditioning unit 20 of the first embodiment will be described. The rear seat foot duct 50 corresponds to a second duct.

FIG. 11 illustrates a configuration of the seat air conditioning unit 20 according to the second embodiment.

In the seat air conditioning unit 20 according to the present embodiment, a rear seat foot duct 50 and valves 60, 61 are added to the seat air conditioning unit 20 of the first embodiment. For that reason, the rear seat foot duct 50 and the valves 60, 61 will be described, and a description of other configurations will be simplified. The valves 60 and 61 correspond to a second air volume adjusting valve.

An air inlet of the rear seat foot duct 50 is connected to a rear seat blowing opening portion 12 of an interior air conditioning unit 10. An air outlet of the rear seat foot duct 50 is connected to the rear seat foot blowing port 51. A rear seat blowing opening portion 12 is a blowing opening portion for blowing out the air conditioning wind controlled in temperature by using a cooling heat exchanger, a heating heat exchanger, an air mixing door, and so on in the interior air conditioning unit 10. The rear seat foot blowing port 51 corresponds to a second rear seat blowing port.

The valve 60 is provided on an air flow upstream side of the rear seat blowing opening portion 12 in the air flow. The valve 60 includes a valve body, which is for regulating an opening area of the rear seat blowing opening portion 12, and an electric actuator that operates the valve body. The valve 61 is provided between the air inlet of the seat air conditioning duct 21 and the sub-fan 22. The valve 61 includes a valve body, which is for adjusting an opening area of the air inlet of the seat air conditioning duct 21, and an electric actuator that operates the valve body.

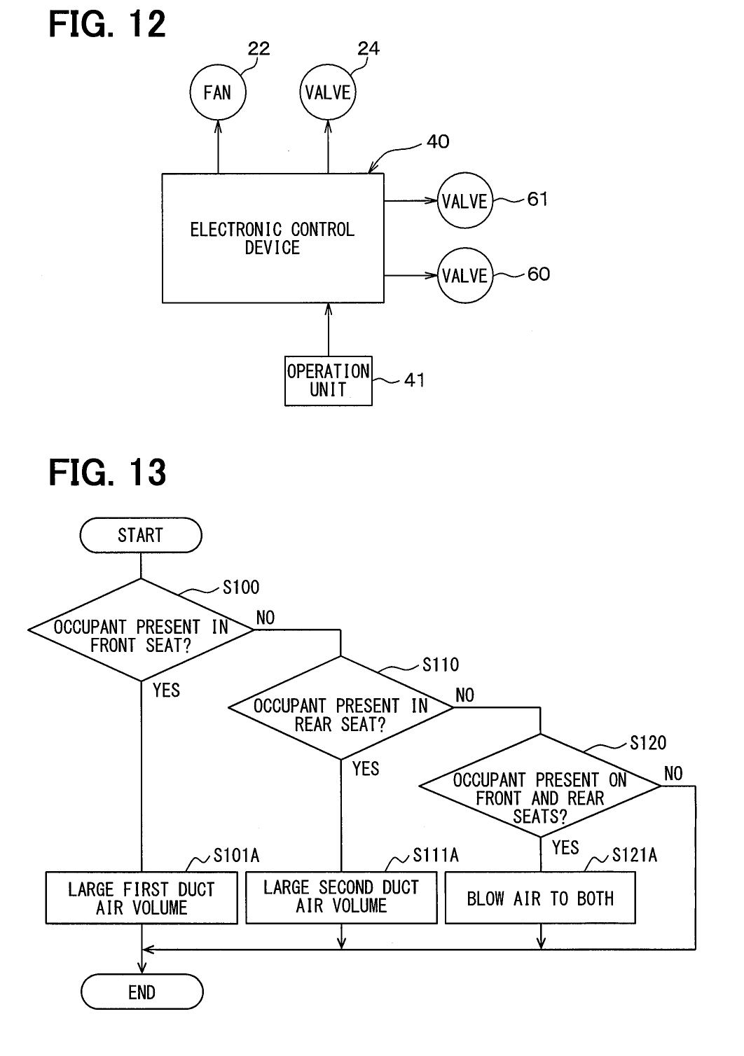

An electric configuration of the seat air conditioning unit 20 according to the present embodiment is illustrated in FIG. 12.

The electronic control device 40 according to the present embodiment executes a seat air conditioning control process and a duct air volume control process. The electronic control device 40 controls the valves 60 and 61 based on an output signal of the operation unit 41 when executing the duct air volume control process. The duct air volume control process is executed in parallel to the seat air conditioning control process.

Subsequently, the duct air volume control process according to the present embodiment will be described with reference to FIG. 13.

FIG. 13 is a flowchart illustrating the duct air volume control process. The electronic control device 40 executes a computer program according to a flowchart illustrated in FIG. 13.

For example, when the occupant is present on the front seat 3 and no occupant is present on the rear seat, the occupant operates the operation unit 41 to give an instruction on setting the volume of air flowing in the seat air conditioning duct 21 to be larger than the volume of air flowing in the rear seat foot duct 50.

In association with the above processing, the electronic control device 40 determines whether the occupant is present on the front seat 3 between the front seat 3 and the rear seat based on the output signal from the operation unit 41 (yes in Step S100).

In this situation, the electronic control device 40 controls the valves 61 and 60 to close the air inlet of the rear seat foot duct 50 and open the air inlet of the seat air conditioning duct 21 (Step S101A). For that reason, the volume of air flowing into the seat air conditioning duct 21 from the interior air conditioning unit 10 is increased more than the volume of air flowing into the rear seat foot duct 50 from the interior air conditioning unit 10.

In this situation, the electronic control device 40 controls the valve 24 to open the seating surface air passage 21b and close the back air passage 23a.

In this case, a majority of the air conditioning wind flowing from the seat air conditioning blowing opening portion 11 of the interior air conditioning unit 10 into the sub-fan 22 and the seat air conditioning duct 21 is blown out toward the occupant through the multiple air flow passages 34 and the multiple seating surface blowing ports.

On the other hand, the air flow flowing from the seat air conditioning blowing opening portion 11 of the interior air conditioning unit 10 through the sub-fan 22 and the seat air conditioning duct 21 will be described. In the above air flow, the remaining air conditioning wind besides most of the air conditioning wind described above is blown out through the back duct 23 from the rear seat face blowing port 25 toward a position corresponding to the upper body of the rear seat.

In addition, when no occupant is present on the front seat 3 and the occupant is present on the rear seat, the occupant operates the operation unit 41 to give an instruction on setting the volume of air flowing in the rear seat foot duct 50 to be larger than the volume of air flowing in the seat air conditioning duct 21.

In association with the above processing, the electronic control device 40 determines whether the occupant is present on the rear seat among the front seat 3 and the rear seat based on the output signal from the operation unit 41 (yes in Step S100). In this situation, in Step S111A, the electronic control device 40 controls the valves 61 and 60 to open the air inlet of the rear seat foot duct 50 and close the air inlet of the seat air conditioning duct 21. For that reason, the volume of air flowing from the interior air conditioning unit 10 into the rear seat foot duct 50 is increased more than the volume of air flowing from the interior air conditioning unit 10 through the seat air conditioning duct 21 into the rear seat foot blowing port 51.

In this situation, the electronic control device 40 controls the valve 24 to close the seating surface air passage 21b and open the back air passage 23a.

In this case, a majority of the air conditioning wind flowing from the seat air conditioning blowing opening portion 11 of the interior air conditioning unit 10 into the sub-fan 22 and the seat air conditioning duct 21 is blown out toward the upper body (in other words, a rear seat side in the vehicle interior) of the occupant on the rear seat from the rear seat face blowing port 25 through the back duct 23.

On the other hand, the remaining air conditioning wind other than the majority of the conditioned air flowing from the seat air conditioning blowing opening portion 11 of the interior air conditioning unit 10 into the sub-fan 22 and the seat air conditioning duct 21 is blown out into the vehicle interior through the multiple air flow passages 34 and the multiple seating surface blowing ports.

In addition, when the occupant is present on the front seat 3 and the occupant is present on the rear seat, the occupant operates the operation unit 41 to give an instruction on blowing out the air conditioning wind having an equivalent air volume to the rear seat foot duct 50 and the seat air conditioning duct 21 from the interior air conditioning unit 10. In association with the above processing, the electronic control device 40 determines whether the occupants are present on the front seat 3 and the rear seat, respectively, based on the output signal from the operation unit 41 (no in Step S110 and yes in Step S120). In this situation, in Step S121A, the electronic control device 40 controls the valves 61 and 60 to open the air inlet of the rear seat foot duct 50 and the air inlet of the seat air conditioning duct 21. For that reason, the air conditioning wind having the equivalent air volume flows from the interior air conditioning unit 10 into the seat air conditioning duct 21 and the rear seat foot duct 50.

In this situation, the electronic control device 40 controls the valve 24 to open the seating surface air passage 21b and the back air passage 23a. For that reason, half of the air conditioning wind flowing from the seat air conditioning blowing opening portion 11 through the sub-fan 22 is blown out toward the occupant through the multiple air flow passages 34 and the multiple seating surface blowing ports. The remaining air conditioning wind is blown out from the rear seat face blowing port 25 toward the upper body of the occupant on the rear seat through the back duct 23. Further, the air conditioning wind flowing from the interior air conditioning unit 10 into the rear seat foot duct 50 is blown out to the lower body of the occupant on the rear seat from the rear seat foot blowing port 51.

According to the present embodiment described above, when the occupant is present on the front seat 3 and no occupant is present on the rear seat, the electronic control device 40 controls the valves 61 and 60. Under the above control, the electronic control device 40 increases the volume of air flowing from the interior air conditioning unit 10 into the seat air conditioning duct 21 more than the volume of air flowing from the interior air conditioning unit 10 into the rear seat foot duct 50. For that reason, the cooling and heating ability by the air conditioning wind flowing in the seat air conditioning duct 21 can be improved.

On the other hand, when no occupant is present on the front seat 3 and the occupant is present on the rear seat, the electronic control device 40 controls the valves 61 and 60. Because of the configuration, the volume of air flowing into the rear seat foot duct 50 from the interior air conditioning unit 10 is increased more than the volume of air flowing from the interior air conditioning unit 10 into the seat air conditioning duct 21. For that reason, the cooling and heating ability by the air conditioning wind flowing in the rear seat foot duct 50 can be improved. For that reason, the air conditioning ability for each seat can be controlled according to whether the occupant is present on each of the front seat 3 and the rear seat, or not.

### Third Embodiment

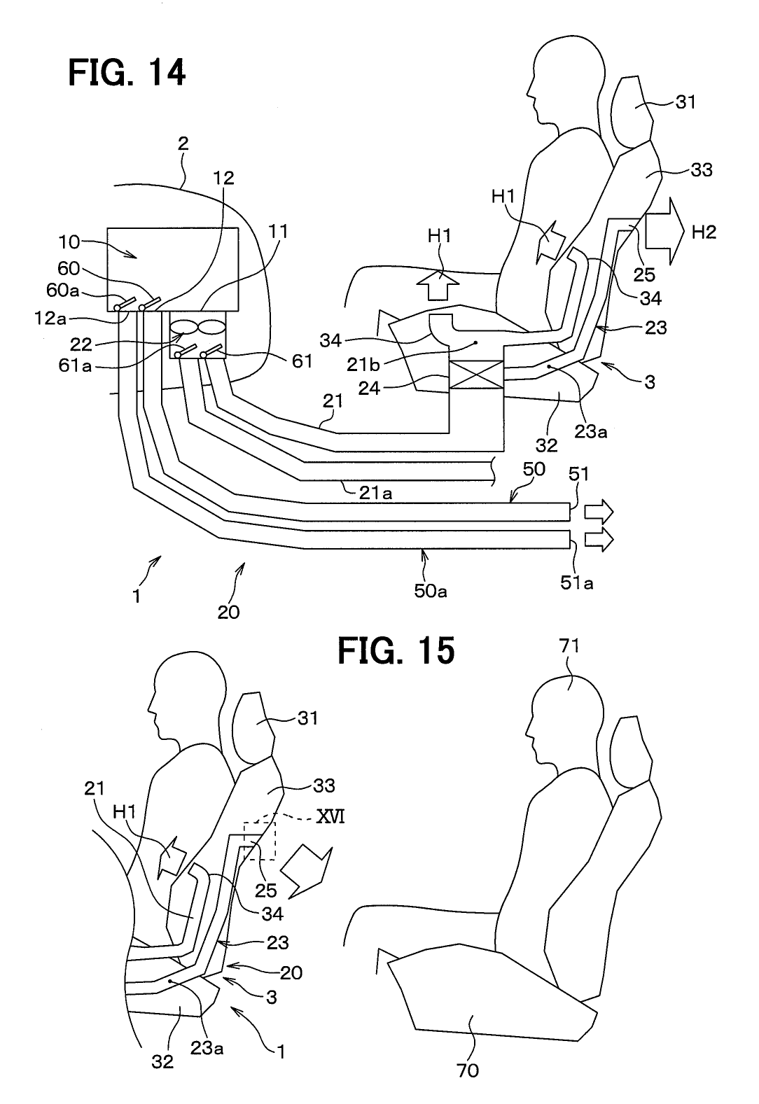

In a third embodiment, an example in which the seat air conditioning unit 20 of the second embodiment is applied to a left front seat and a right front seat will be described with reference to FIG. 14.

FIG. 14 illustrates a configuration of the seat air conditioning unit 20 according to the third embodiment.

In addition to a seat air conditioning duct 21 and a rear seat foot duct 50, the seat air conditioning unit 20 according to the present embodiment includes a seat air conditioning duct 21a and a rear seat foot duct 50a.

First, in the present embodiment, as with the front seat 3 according to the first embodiment, multiple seating surface blowing ports are provided in seating surfaces of a left front seat and a right front seat, and a rear seat face blowing port 25 is provided on a back surface of each front seat. Multiple seating surface blowing ports provided in the left front seat correspond to multiple left seating surface blowing ports. Multiple seating surface blowing ports provided in the right front seat correspond to multiple right seating surface blowing ports. The rear seat face blowing port 25 of the left front seat back surface corresponds to a left rear seat blowing port. The rear seat face blowing port 25 of the right front seat back surface corresponds to a right rear seat blowing port.

In this example, the seat air conditioning duct 21 is provided between the multiple seating surface blowing ports and the rear seat face blowing port 25 in the left front seat and the seat air conditioning blowing opening portion 11 of the interior air conditioning unit 10. The seat air conditioning duct 21 is formed so as to extend from an inside of the instrument panel 2 to the left front seat side and is coupled to the left front seat. The seat air conditioning duct 21 corresponds to a left duct.

The seat air conditioning duct 21a is provided between the multiple seating surface blowing ports and the rear seat face blowing port 25 in the right front seat and the seat air conditioning blowing opening portion 11 of the interior air conditioning unit 10. The seat air conditioning duct 21a is formed so as to extend from an inside of the instrument panel 2 to the right front seat side and is coupled to the right front seat. The seat air conditioning duct 21a corresponds to a right duct.

The rear seat foot duct 50 is provided between a rear seat blowing opening portion 12 of an interior air conditioning unit 10 and a left rear seat foot blowing port 51. The left rear seat foot blowing port 51 blows out the air conditioning wind to a lower body of the occupant on the left rear seat. The rear seat foot duct 50a is provided between a rear seat blowing opening portion 12a of an interior air conditioning unit 10 and a right rear seat foot blowing port 51a. The right rear seat foot blowing port 51a blows out the air conditioning wind to a lower body of the occupant on the right rear seat. The rear seat foot duct 50a corresponds to a second foot duct.

The valve 60 is provided on an air flow upstream side of the rear seat blowing opening portion 12 in the air flow. The valve 60 includes a valve body for regulating an opening area of the rear seat blowing opening portion 12 and an electric actuator that operates the valve body.

The valve 60a is provided on an air flow upstream side of the rear seat blowing opening portion 12a in the air flow. The valve 60a includes a valve body for regulating an opening area of the rear seat blowing opening portion 12a and an electric actuator that operates the valve body.

The valve 61 is provided between the air inlet of the seat air conditioning duct 21 and the sub-fan 22. The valve 61 includes a valve body for adjusting an opening area of the air inlet of the seat air conditioning duct 21 and an electric actuator that operates the valve body.

The valve 61a is provided between the air inlet of the seat air conditioning duct 21a and the sub-fan 22. The valve 61a includes a valve body for regulating an opening area of the air inlet of the seat air conditioning duct 21a and an electric actuator that operates the valve body. The valves 60, 60a, 61, and 61a are controlled by the electronic control device 40.

In the present embodiment, the sub-fan 22 is provided between the respective air inlets of the seat air conditioning ducts 21, 21a and the seat air conditioning blowing opening portion 11.

According to the present embodiment described above, the electronic control device 40 executes a seat air conditioning control process and a duct air volume control process on the left front seat and the left front seat independently for each seat. For that reason, the electronic control device 40 controls the valves 60, 60a, 61, and 61a and the respective valves 24 of the left front seat and the left front seat.

Therefore, the electronic control device 40 can control the respective air volumes blown out from the multiple seating surface blowing ports and the rear seat face blowing port 25 of the left front seat, the respective air volumes blown out from the multiple seating surface blowing ports and the rear seat face inlet 25 of the right front seat, the volume of air blown out from the left rear seat foot blowing port 51, and the volume of air blown out from the right rear seat foot blowing port 51a, independently. Because of the configuration, the electronic control device 40 can control the respective air conditioning abilities of the right front seat, the left front seat, the right rear seat, and the left rear seat, independently.

For example, when the occupant is present on each of the right front seat, the left front seat, and the right rear seat, and the occupant is not present on the left rear seat, the following air volume is created. In other words, the volume of air blown out from the multiple seating surface blowing ports of the right front seat and the volume of air blown out from the right rear seat face blowing port 25 are the same. At the same time, the volume of air blown out from the multiple seating surface blowing ports of the left front seat is larger than the volume of air blown out from the left rear seat face blowing port 25.

For example, when the occupant is present on each of the right front seat and the left rear seat, and occupant is not present on the right rear seat and the left front seat, the following air volume is created. In other words, the volume of air blown out from the multiple seating surface blowing ports of the right front seat is larger than the volume of air blown out from the right rear seat face blowing port 25. At the same time, the volume of air blown out from the multiple seating surface blowing ports of the left front seat is smaller than the volume of air blown out from the left rear seat face blowing port 25.

### Fourth Embodiment

Subsequently, a fourth embodiment will be described with reference to FIGS. 15, 16, 17, 18 and 19. In a vehicle air conditioning apparatus 1 according to the present embodiment, members are added in the vicinity of a rear seat face blowing port 25 to the vehicle air conditioning apparatus 1 according to the first, second and third embodiments. Because of the configuration, as illustrated in FIG. 15, an air flow passing through a back air passage 23a in a back duct 23 is blown out from a rear seat face blowing port 25 toward a lower body of an occupant 71 seated on a rear seat 70 behind a front seat 3.

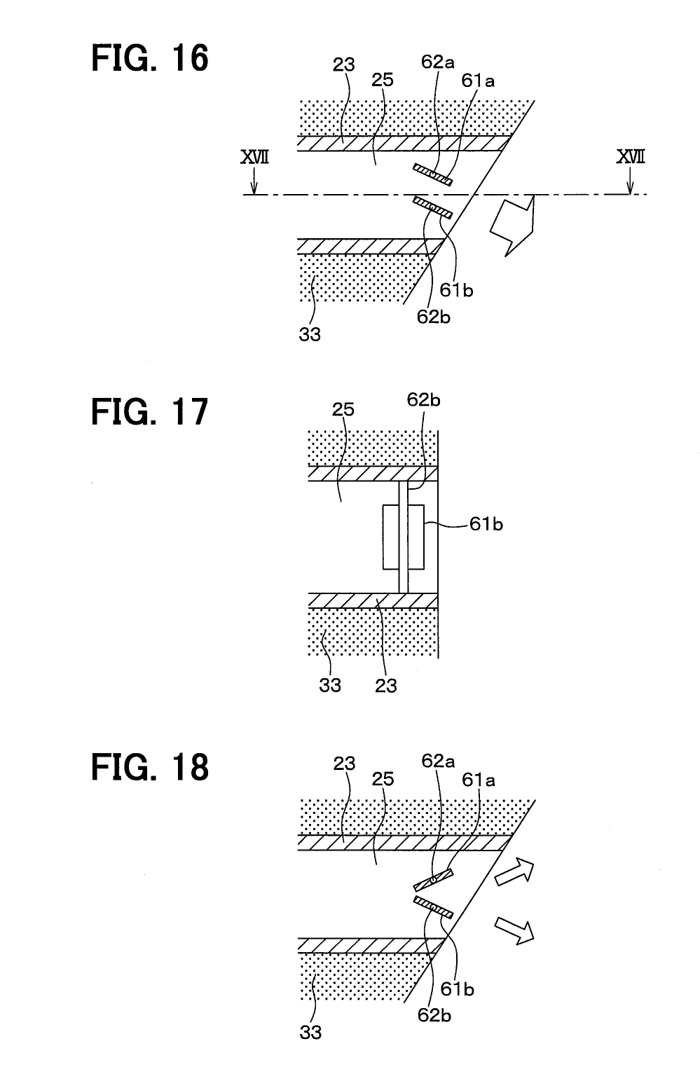

The members added in the vicinity of the rear seat face blowing port 25 include vertical adjustment louvers 61a, 61b and vertical adjustment shafts 62a, 62b shown in FIGS. 16 and 17. Those members 61a, 61b, 62a, and 62b are provided in a portion surrounded by a rear seat face blowing port 25 in the back air passage 23a. FIG. 16 is a cross-sectional view (that is, a vertical cross-sectional view) of the back duct 23 and the like taken along a plane orthogonal to a vehicle width direction.

The vertical adjustment shaft 62a is configured with a rod-shaped member extending in the width direction of the vehicle. Both ends of the vertical adjustment shaft 62a are pivoted by the back duct 23. Because of the configuration, the vertical adjustment shaft 62a is rotatable with respect to the back duct 23. The vertical adjustment louver 61a is configured with a flat plate member and is fixed to the vertical adjustment shaft 62a. Accordingly, when the vertical adjustment shaft 62a rotates, the vertical adjustment louver 61a also rotates integrally with the vertical adjustment shaft 62a.

In the preceding paragraph, a configuration in which the vertical adjustment louver 61a and the vertical adjustment shaft 62a are replaced with the vertical adjustment louver 61b and the vertical adjustment shaft 62b is also feasible. Each of the vertical adjustment louvers 61a and 61b corresponds to a bending portion that bends the air flow passing through the rear seat face blowing port 25.

The vertical adjustment shaft 62a and the vertical adjustment shaft 62b are arranged side by side in a vertical direction of the vehicle. More specifically, the vertical adjustment shaft 62a is provided above the vertical adjustment shaft 62b. An extending direction of the vertical adjustment shaft 62a is in parallel to an extending direction of the vertical adjustment shaft 62b.

The vertical adjustment louver 61a and the vertical adjustment louver 61b are also arranged side by side in the vertical direction of the vehicle. More specifically, the vertical adjustment louver 61a is provided above the vertical adjustment louver 61b.

The vertical adjustment shaft 62a is connected to a vertical adjustment motor A through a power transmission mechanism A not shown (for example, a gear mechanism). Further, the vertical adjustment shaft 62b is connected to a vertical adjustment motor B through a power transmission mechanism B not shown (for example, a gear mechanism).

The electronic control device 40 controls the vertical adjustment motor A and the vertical adjustment motor B, independently, based on an output signal of the operation unit 41 when executing the seat air conditioning control process. Because of the configuration, the electronic control device 40 can adjust postures of the vertical adjustment louvers 61a and 61b, independently. More specifically, the postures to be adjusted are rotation angle positions of the vertical adjustment louvers 61a and 61b with the vertical adjustment shafts 62a and 62b as rotation axes.

For example, in a state illustrated in FIG. 16, each of the vertical adjustment louvers 61a and 61b is inclined facing downward on a downstream side. In other words, a position of a surface of each of the vertical adjustment louvers 61a and 61b in the vertical direction of the vehicle gradually changes in a downward direction of the vehicle toward the downstream side of the air flow from the upstream side. In this situation, a plate surface of the vertical adjustment louver 61a and a plate surface of the vertical adjustment louver 61b are in parallel to each other. An inner wall of the rear seat face blowing port 25 extends straight in a longitudinal direction of the vehicle.

In such a state illustrated in FIG. 16, after the air flow passing through the back air passage 23a in the back duct 23 has flowed in a longitudinal direction of the vehicle, a direction of the air flow is changed by the vertical adjustment louvers 61a and 61b. Because of the configuration, as illustrated in FIGS. 15 and 16, the air flow is blown out from the rear seat face blowing port 25 toward a lower body of an occupant 71 seated on a rear seat 70 behind a front seat 3. With the above configuration, as compared with the first, second and third embodiments, the direction of the air flow sent to the rear seat can be directed further downward.

In addition, in a state illustrated in FIG. 18, the vertical adjustment louver 61a is inclined facing upward on a downstream side. In other words, a position of a surface of the vertical adjustment louver 61a in the vertical direction of the vehicle gradually changes in an upward direction of the vehicle toward the downstream side of the air flow from the upstream side. In addition, the vertical adjustment louver 61b is inclined facing downward on a downstream side. Therefore, the plate surface of the vertical adjustment louver 61a and the plate surface of the vertical adjustment louver 61b are separated from each other toward the downstream side.

In such a state illustrated in FIG. 18, after the air flow passing through the back air passage 23a in the back duct 23 has flowed in a longitudinal direction of the vehicle, a direction of the air flow is changed by the vertical adjustment louvers 61a and 61b. More specifically, the air flow is bent upward by the vertical adjustment louver 61a, and the air flow is bent downward by the vertical adjustment louver 61b.

Because of the configuration, as illustrated in FIG. 18, the air is blown out while spreading out from the rear seat face blowing port 25 diagonally upward in the rear direction as well as obliquely downward in the rear direction. Therefore, the air is blown out toward the upper body and the lower body of the occupant 71 seated on the rear seat 70 behind the front seat 3.

With the above configuration, as compared with the first, second and third embodiments, the direction of the air flow sent to the rear seat can be directed further downward. At the same time, as compared with the first, second and third embodiments, an area of the air flow sent to the rear seat can be expanded both in the upward direction and the downward direction. In addition, a flow channel cross-sectional area of the air flow sent to the rear seat can be expanded both in the upward direction and the downward direction. In this case, the air flow is delivered in a wide range of the occupant on the rear seat, thereby being capable of improving the comfort.

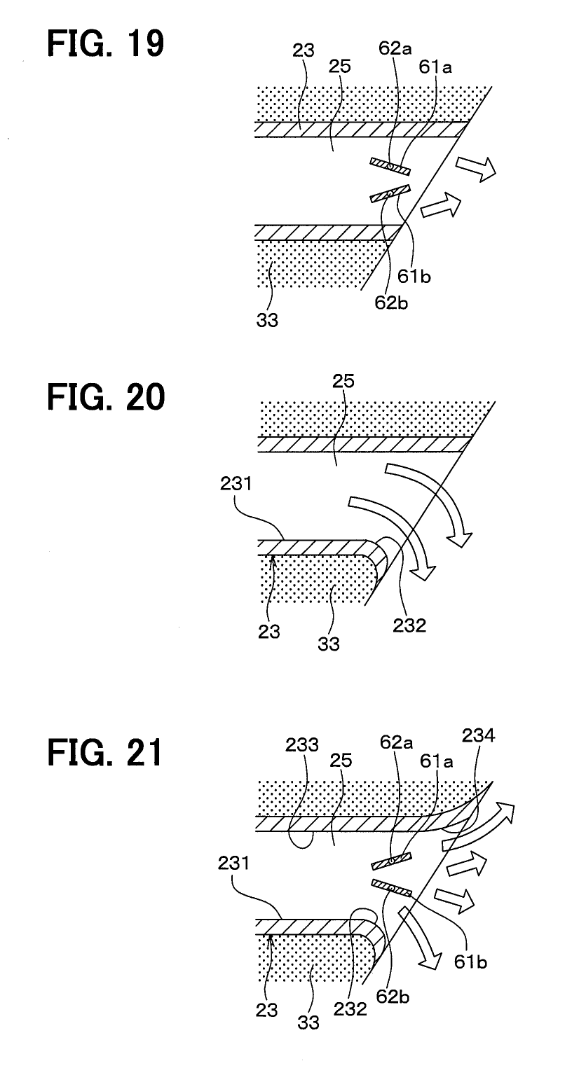

In addition, in a state illustrated in FIG. 19, the vertical adjustment louver 61a is inclined facing downward on a downstream side. In addition, the vertical adjustment louver 61b is inclined facing upward on a downstream side. Therefore, the plate surface of the vertical adjustment louver 61a and the plate surface of the vertical adjustment louver 61b approach each other toward the downstream side.

In such a state illustrated in FIG. 19, after the air flow passing through the back air passage 23a in the back duct 23 has flowed in a longitudinal direction of the vehicle, a direction of the air flow is changed by the vertical adjustment louvers 61a and 61b. More specifically, the air flow is bent upward by the vertical adjustment louver 61a, and the air flow is bent downward by the vertical adjustment louver 61b.

Because of the configuration, as illustrated in FIG. 19, the air flow is blown out from the rear seat face blowing port 25 narrowly in the vertical direction.

With the above configuration, as compared with the first, second and third embodiments, the area of the air flow sent to the rear seat can be narrowed both in the upward direction and the downward direction. In addition, the flow channel cross-sectional area of the air flow sent to the rear seat can be reduced both in the upward direction and the downward direction. In this case, the air flow is intensively delivered to the occupant on the rear seat, thereby being capable of improving the comfort.

In this way, in the present embodiment, the vertical adjustment louvers 61a, 61b can bend the air flow passing through the rear seat face blowing port 25 in the vertical direction of the vehicle and change a direction of the air flow in the vehicle vertical direction.

In addition, the vertical adjustment louvers 61a and 61b can change the degree of diffusion of the air flow blown out of the rear seat face blowing port 25 through the rear seat face blowing port 25. Specifically, the vertical adjustment louvers 61a and 61b can spread the air flow in the vertical direction of the vehicle toward the downstream of the air flow. Further, the vertical adjustment louvers 61a and 61b can narrow the air flow toward the downstream side of the air flow in the vertical direction of the vehicle. Therefore, since the air flow can be delivered intensively or in a wide range, the comfort of the occupant on the rear seat is improved.

### Fifth Embodiment

Subsequently, a fifth embodiment will be described. In a vehicle air conditioning apparatus 1 according to the present embodiment, a shape of a rear seat face blowing port 25 is modified as compared with the vehicle air conditioning apparatus 1 according to the first, second and third embodiments. Because of the configuration, as illustrated in FIG. 15, an air flow passing through a back air passage 23a in a back duct 23 is blown out from a rear seat face blowing port 25 toward a lower body of an occupant 71 seated on a rear seat 70 behind a front seat 3.

Specifically, the rear seat face blowing port 25 according to the present embodiment is shaped as illustrated in FIG. 20. In other words, the shapes of an upper wall surface, a right wall surface, and a left wall surface among inner wall surfaces formed in the rear seat face blowing port 25 according to the present embodiments are not modified, and only a lower wall surface is modified. The lower wall surface has an upstream wall surface 231 and a downstream wall surface 232. The downstream wall surface 232 corresponds to a bending portion. The inner wall surface of the rear seat face blowing port 25 is a wall surface facing a portion surrounded by the rear seat face blowing port 25 of the back air passage 23a.

The upstream wall surface 231 extends straight rearward relative to the vehicle. More specifically, a line at a portion where an arbitrary plane perpendicular to the vehicle width direction intersects with the upstream wall surface 231 is a straight line parallel to the vehicle longitudinal direction. A vertical inclination angle of that line with respect to the vehicle longitudinal direction is kept constant, that is, 0°. Therefore, the air flow passing above the upstream wall surface 231 proceeds toward the rear side of the vehicle. When the position of the line in the vertical direction of the vehicle decreases more as the line goes toward the rear of the vehicle more, the vertical inclination angle of the line with respect to the vehicle longitudinal direction becomes positive.

The downstream wall surface 232 is smoothly connected to a downstream end of the upstream wall surface 231. Therefore, the downstream wall surface 232 is located at a downstream side end portion of the rear seat face blowing port 25. The downstream wall surface 232 is smoothly bent toward the bottom of the vehicle while extending toward the rear of the vehicle. In other words, the downstream wall surface 232 has an R shape with a rounded convex facing upward relative to the vehicle. More specifically, the vertical inclination angle of the line, where the arbitrary plane perpendicular to the vehicle width direction intersects with the downstream wall surface 232, with respect to the vehicle longitudinal direction is a positive value. The vertical inclination angle of that line increases more toward the rear of the vehicle.

Therefore, the radius of curvature of an arbitrary portion of the line, where an arbitrary plane perpendicular to the vehicle width direction intersects with the downstream wall surface 232, is smaller than the radius of curvature of any portion of the line where the plane intersects with the upstream wall surface 231.

With the above configuration, the air flow passing above the downstream wall surface 232 is bent downward relative to the vehicle due to the Coanda effect attributable to the shape of the downstream wall surface 232. Because of the configuration, as illustrated in FIGS. 15 and 20, the air that has left the face blowing port 25 is blown out toward the lower body of the occupant 71 seated on the rear seat 70.

In this way, in the present embodiment, the air flow passing through the rear seat face blowing port 25 can be bent downward in the vertical direction and the vertical direction of the air flow can be changed.

In addition, the downstream wall surface 232 can change the degree of diffusion of the air flow blown out of the rear seat face blowing port 25 through the rear seat face blowing port 25. Specifically, the downstream wall surface 232 can spread the air flow on a lower side of the vehicle in the vertical direction toward the downstream of the air flow. Therefore, since the air flow can be delivered in a wide range, the comfort of the occupant on the rear seat is improved.

### Sixth Embodiment

Subsequently, a sixth embodiment will be described. In a vehicle air conditioning apparatus 1 according to the present embodiment, a shape of a rear seat face blowing port 25 is modified as compared with the vehicle air conditioning apparatus 1 according to the fourth embodiment.

Specifically, the rear seat face blowing port 25 according to the present embodiment is shaped as illustrated in FIG. 21. In other words, the shapes of a right wall surface and a left wall surface among inner wall surfaces formed in the rear seat face blowing port 25 according to the present embodiment are not modified, and an upper wall surface and a lower wall surface are modified. The lower wall surface has an upstream wall surface 231 and a downstream wall surface 232. The upper wall surface has an upstream wall surface 233 and a downstream wall surface 234. Each of the downstream wall surfaces 232 and 234 corresponds to a bending portion. The shapes of the upstream wall surface 231 and the downstream wall surface 232 are identical with those in the fifth embodiment.

The upstream wall surface 233 extends straight rearward relative to the vehicle. More specifically, a line at a portion, where an arbitrary plane perpendicular to the vehicle width direction intersects with the upstream wall surface 233, is a straight line parallel to the vehicle longitudinal direction. A vertical inclination angle of that line with respect to the vehicle longitudinal direction is kept constant, that is, 0°. Therefore, the air flow passing above the upstream wall surface 233 proceeds toward the rear of the vehicle.

The downstream wall surface 234 is smoothly connected to a downstream end of the upstream wall surface 233. Therefore, the downstream wall surface 234 is located at a downstream side end portion of the rear seat face blowing port 25. The downstream wall surface 234 is smoothly bent upward relative to the vehicle while extending toward the rear of the vehicle. In other words, the downstream wall surface 234 has an R shape with a rounded convex facing downward relative to the vehicle. More specifically, a vertical inclination angle of a line where an arbitrary plane perpendicular to the vehicle width direction intersects with the downstream wall surface 234 with respect to the vehicle longitudinal direction is a negative value. An absolute value of the vertical inclination angle of that line increases more toward the rear of the vehicle.

Therefore, the radius of curvature of an arbitrary portion of the line, where an arbitrary plane perpendicular to the vehicle width direction intersects with the downstream wall surface 234, is smaller than the radius of curvature of any portion of the line where the plane intersects with the upstream wall surface 233.

With the above configuration, the air flow passing below the downstream wall surface 234 is bent upward relative to the vehicle due to the Coanda effect attributable to the shape of the downstream wall surface 234. At the same time, the air flow passing above the downstream wall surface 232 is bent downward relative to the vehicle due to the Coanda effect attributable to the shape of the downstream wall surface 232. Therefore, as illustrated in FIG. 21, the air that has left the face blowing port 25 is blown out toward the lower body and the upper body of the occupant 71 seated on the rear seat 70.

It should be noted that the vertical adjustment louvers 61a and 61b according to the present embodiment are controlled in posture similarly to the fourth embodiment.

As described above, the present embodiment can produce the same advantages as those in the fourth embodiment. In addition, the air flow passing through the rear seat face blowing port 25 can be bent to both upward and downward in the vertical direction, and the vertical direction of the air flow can be changed.

In addition, the downstream wall surfaces 232 and 234 can change the degree of diffusion of the air flow blown out of the rear seat face blowing port 25 through the rear seat face blowing port 25. Specifically, the downstream wall surfaces 232 and 234 can spread the air flow on an upper side and a lower side of the vehicle in the vertical direction toward the downstream of the air flow. Therefore, since the air flow can be delivered in a wide range, the comfort of the occupant on the rear seat is improved.

### Seventh Embodiment

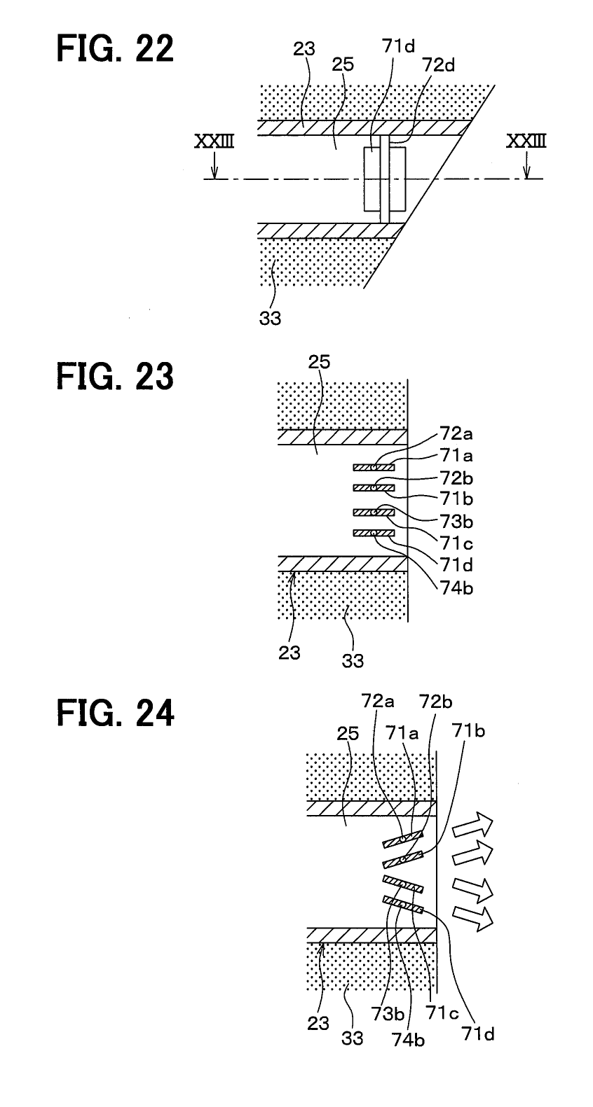

Subsequently, a seventh embodiment will be described with reference to FIGS. 22, 23, 24, and 25. In a vehicle air conditioning apparatus 1 according to the present embodiment, members are added in the vicinity of a rear seat face blowing port 25 to the vehicle air conditioning apparatus 1 according to the first, second and third embodiments.

The members added in the vicinity of the rear seat face blowing port 25 include horizontal adjustment louvers 71a, 71b, 71c, 71d and horizontal adjustment shafts 72a, 72b, 72c, 72d illustrated in FIGS. 22 and 23. Those members 71a, 71b, 71c, 71d, 72a, 72b, 72c, and 72d are provided in a portion surrounded by the rear seat face blowing port 25 in the back air passage 23a. FIG. 22 is a vertical cross-sectional view of the back duct 23 and the like taken along a plane orthogonal to the vehicle width direction.

The horizontal adjustment shaft 72a is configured with a rod-shaped member extending in the vertical direction of the vehicle. Both ends of the horizontal adjustment shaft 72a are pivoted by the back duct 23. Because of the configuration, the horizontal adjustment shaft 72a is rotatable with respect to the back duct 23. The horizontal adjustment louver 71a is configured with a flat plate member and is fixed to the horizontal adjustment shaft 72a. Accordingly, when the horizontal adjustment shaft 72a rotates, the horizontal adjustment louver 71a also rotates integrally with the horizontal adjustment shaft 72a.

In the preceding paragraph, a configuration in which the horizontal adjustment louver 71a and the horizontal adjustment shaft 72a are replaced with the horizontal adjustment louver 71b and the horizontal adjustment shaft 72b is also feasible. In the preceding paragraph, a configuration in which the horizontal adjustment louver 71a and the horizontal adjustment shaft 72a are replaced with the horizontal adjustment louver 71c and the horizontal adjustment shaft 72c is also feasible. In the preceding paragraph, a configuration in which the horizontal adjustment louver 71a and the horizontal adjustment shaft 72a are replaced with the horizontal adjustment louver 71d and the horizontal adjustment shaft 72d is also feasible. Each of the horizontal adjustment louvers 71a, 71b, 71c, and 71d corresponds to a bending portion that bends the air flow passing through the rear seat face blowing port 25.

As illustrated in FIG. 23, the horizontal adjustment shafts 72a, 72b, 72c, and 72d are aligned in the vehicle width direction. The extending directions of the horizontal adjustment shafts 72a, 72b, 72c, and 72d are parallel to each other. In addition, the horizontal adjustment louvers 71a, 71b, 71c, and 71d are also aligned in the vehicle width direction.

The horizontal adjustment shaft 72a is connected to a horizontal adjustment motor P through a power transmission mechanism P not shown (for example, a gear mechanism). The horizontal adjustment shaft 72b is connected to a horizontal adjustment motor Q through a power transmission mechanism Q not shown (for example, a gear mechanism). The horizontal adjustment shaft 72c is connected to a horizontal adjustment motor R through a power transmission mechanism R not shown (for example, a gear mechanism). The horizontal adjustment shaft 72d is connected to a horizontal adjustment motor S through a power transmission mechanism S not shown (for example, a gear mechanism).

The electronic control device 40 controls the horizontal adjustment motor P, the horizontal adjustment motor B, the horizontal adjustment motor Q, the horizontal adjustment motor R, and the horizontal adjustment motor S, independently, based on an output signal of the operation unit 41 when executing the seat air conditioning control process. Because of the configuration, the electronic control device 40 can adjust postures of the horizontal adjustment louvers 71a, 71b, 71c, and 71d, independently. More specifically, the postures to be adjusted are rotation angle positions of the horizontal adjustment louvers 71a, 71b, 71c, and 71d with the horizontal adjustment shafts 72a, 72b, 72c, and 72d as rotation axes.

For example, in a state illustrated in FIG. 23, each of the horizontal adjustment louvers 71a, 71b, 71c, and 71d is in an attitude that does not incline in the horizontal direction, that is, in a posture that is orthogonal to the vehicle width direction. At this time, the plate surfaces of the horizontal adjustment louvers 71a, 71b, 71c, and 71d are parallel to each other. An inner wall of the rear seat face blowing port 25 extends straight in a longitudinal direction of the vehicle.

In addition, in a state illustrated in FIG. 24, the horizontal adjustment louvers 71a and 71b are inclined with a downstream side facing rightward in the vehicle width direction. In other words, a position of a surface of each of the horizontal adjustment louvers 71a and 71b in the vehicle width direction gradually changes to the right in the vehicle width direction toward the downstream side of the air flow from the upstream side. In addition, the horizontal adjustment louvers 71c and 71d are inclined with a downstream side facing leftward in the vehicle width direction. Therefore, the plate surfaces of the horizontal adjustment louvers 71a and 71b are separated from the plate surfaces of the horizontal adjustment louvers 71c and 71d toward the downstream side.

In such a state illustrated in FIG. 24, after the air flow passing through the back air passage 23a in the back duct 23 has flowed in the longitudinal direction of the vehicle, a direction of the air flow is changed by the horizontal adjustment louvers 71a, 71b, 71c and 71d. Specifically, the air flow is bent to the right side in the vehicle width direction by the horizontal adjustment louvers 71a and 71b, and the airflow is bent to the left side in the vehicle width direction by the horizontal adjustment louvers 71c and 71d.

Because of the configuration, as illustrated in FIG. 24, the air flow is blown out while spreading out from the rear seat face blowing port 25 diagonally rightward in the rear direction as well as obliquely rightward in the rear direction.

With the above configuration, the area of the air flow sent to the rear seat can be expanded to both of right and left in the vehicle width direction. In addition, a flow channel cross-sectional area of the air flow sent to the rear seat can be expanded to both of the right and the left in the vehicle width direction. In this case, the air flow is delivered in a wide range of the occupant on the rear seat, thereby being capable of improving the comfort.

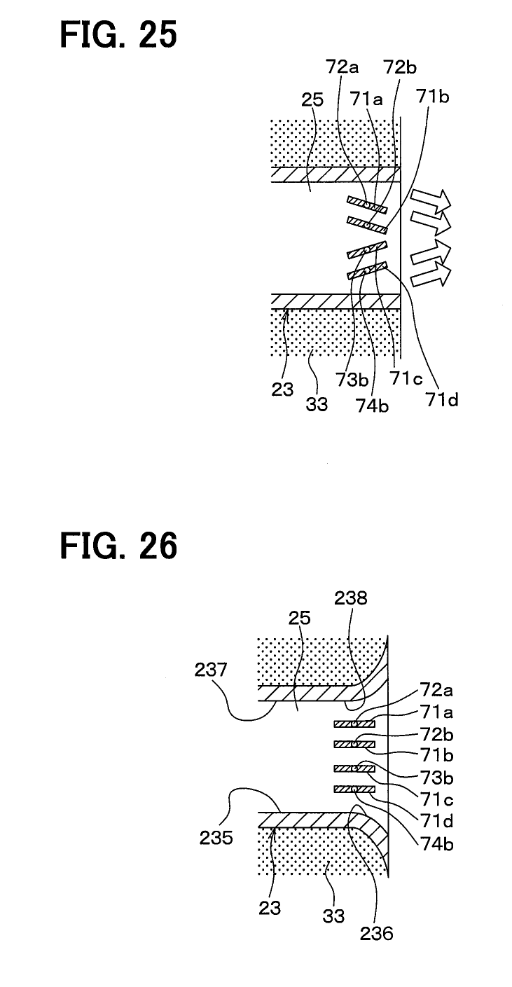

In addition, in a state illustrated in FIG. 25, the horizontal adjustment louvers 71a and 71b are inclined with a downstream side facing leftward in the vehicle width direction. In addition, the horizontal adjustment louvers 71c and 71d are inclined with a downstream side facing rightward in the vehicle width direction. Therefore, the plate surfaces of the horizontal adjustment louvers 71a and 71b approach the plate surfaces of the horizontal adjustment louvers 71c and 71d toward the downstream side.

In such a state illustrated in FIG. 25, after the air flow passing through the back air passage 23a in the back duct 23 has flowed in the longitudinal direction of the vehicle, a direction of the air flow is changed by the horizontal adjustment louvers 71a, 71b, 71c and 71d. Specifically, the air flow is bent to the left in the vehicle width direction by the horizontal adjustment louvers 71a and 71b, and the airflow is bent to the right in the vehicle width direction by the horizontal adjustment louvers 71c and 71d.

Because of the configuration, as illustrated in FIG. 25, the air flow is blown out from the rear seat face blowing port 25 narrowly in the vehicle width direction.

With the above configuration, as compared with the first, second and third embodiments, the area of the air flow sent to the rear seat can be narrowed both of rightward and leftward in the vehicle width direction. In addition, the flow channel cross-sectional area of the air flow sent to the rear seat can be reduced both of rightward and leftward in the vehicle width direction. In this case, the air flow is intensively delivered to the occupant on the rear seat, thereby being capable of improving the comfort.

In this way, in the present embodiment, the horizontal adjustment louvers 71a, 71b, 71c, and 71d can bend the air flow passing through the rear seat face blowing port 25 in the vertical direction of the vehicle and change a direction of the air flow in the vehicle vertical direction.

In addition, the horizontal adjustment louvers 71a, 71b, 71c, and 71d can change the degree of diffusion of the air flow blown out of the rear seat face blowing port 25 through the rear seat face blowing port 25. Specifically, the horizontal adjustment louvers 71a, 71b, 71c, and 71d can spread the air flow in the vehicle width direction toward the downstream of the air flow. In addition, the horizontal adjustment louvers 71a, 71b, 71c, and 71d can narrow the air flow in the vehicle width direction toward the downstream of the air flow. Therefore, since the air flow can be delivered intensively or in a wide range, the comfort of the occupant on the rear seat is improved.

### Eighth Embodiment

Subsequently, an eighth embodiment will be described. In a vehicle air conditioning apparatus 1 according to the present embodiment, a shape of a rear seat face blowing port 25 is modified as compared with the vehicle air conditioning apparatus 1 according to the seventh embodiment.

Specifically, the rear seat face blowing port 25 according to the present embodiment is shaped as illustrated in FIG. 26. In other words, the shapes of an upper wall surface and a lower wall surface among inner wall surfaces formed in the rear seat face blowing port 25 according to the present embodiments are not modified, and a right wall surface and a left wall surface are modified. FIG. 26 is a cross-sectional view (that is, a horizontal cross-sectional view) of the back duct 23 and the like taken along a plane orthogonal to a vehicle vertical direction.

The left wall surface has an upstream wall surface 235 and a downstream wall surface 236. The right wall surface has an upstream wall surface 237 and a downstream wall surface 238. Each of the downstream wall surfaces 236 and 238 corresponds to a bending portion.

The upstream wall surface 235 extends straight rearward relative to the vehicle. More specifically, a line at a portion where an arbitrary plane perpendicular to the vehicle vertical direction intersects with the upstream wall surface 235 is a straight line parallel to the vehicle longitudinal direction. A horizontal inclination angle of that line with respect to the vehicle longitudinal direction is kept constant, that is, 0°. Therefore, the air flow passing above the upstream wall surface 235 proceeds toward the rear of the vehicle. When the position of the line in the vehicle width direction moves to the left more as the line goes toward the rear of the vehicle more, the horizontal inclination angle of the line with respect to the vehicle longitudinal direction becomes positive.

The downstream wall surface 236 is smoothly connected to an downstream end of the upstream wall surface 235. Therefore, the downstream wall surface 236 is located at a downstream side end portion of the rear seat face blowing port 25. The downstream wall surface 236 is smoothly bent to the left of the vehicle while extending toward the rear of the vehicle. In other words, the downstream wall surface 236 has an R shape with a rounded convex facing rightward in the vehicle width direction. More specifically, a horizontal inclination angle of a line where an arbitrary plane perpendicular to the vehicle vertical direction intersects with the downstream wall surface 236 with respect to the vehicle longitudinal direction is a positive value. An absolute value of the inclination angle of that line increases more toward the rear of the vehicle.

Therefore, the radius of curvature of an arbitrary portion of the line where an arbitrary plane perpendicular to the vehicle vertical direction intersects with the downstream wall surface 236 is smaller than the radius of curvature of any portion of the line where the plane intersects with the upstream wall surface 235.

The upstream wall surface 237 extends straight rearward relative to the vehicle. More specifically, a line at a portion where an arbitrary plane perpendicular to the vehicle vertical direction intersects with the upstream wall surface 237 is a straight line parallel to the vehicle longitudinal direction. A horizontal inclination angle of that line with respect to the vehicle longitudinal direction is kept constant, that is, 0°. Therefore, the air flow passing above the upstream wall surface 237 proceeds toward the rear of the vehicle.

The downstream wall surface 238 is smoothly connected to an downstream end of the upstream wall surface 237. Therefore, the downstream wall surface 238 is located at a downstream side end portion of the rear seat face blowing port 25. The downstream wall surface 238 is smoothly bent to the right of the vehicle while extending toward the rear of the vehicle. In other words, the downstream wall surface 238 has an R shape with a rounded convex facing leftward in the vehicle width direction. More specifically, a horizontal inclination angle of a line where an arbitrary plane perpendicular to the vehicle vertical direction intersects with the downstream wall surface 238 with respect to the vehicle longitudinal direction is a negative value. An absolute value of the inclination angle of that line increases more toward the rear of the vehicle.

Therefore, the radius of curvature of an arbitrary portion of the line where an arbitrary plane perpendicular to the vehicle vertical direction intersects with the downstream wall surface 238 is smaller than the radius of curvature of any portion of the line where the plane intersects with the upstream wall surface 237.

With the above configuration, the air flow passing through the right of the downstream wall surface 236 is bent leftward relative to the vehicle due to the Coanda effect attributable to the shape of the downstream wall surface 236. At the same time, the air flow passing through the left of the downstream wall surface 238 is bent downward relative to the vehicle due to the Coanda effect attributable to the shape of the downstream wall surface 238.

It should be noted that the horizontal adjustment louvers 71a, 71b, 71c, and 71d according to the present embodiment are controlled in posture similarly to the seventh embodiment.

As described above, the present embodiment can produce the same advantages as those in the seventh embodiment. In addition, the downstream wall surfaces 236 and 238 can change the degree of diffusion of the air flow blown out of the rear seat face blowing port 25 through the rear seat face blowing port 25. Specifically, the downstream wall surfaces 236 and 238 can spread the air flow on a left side and a right side in the vehicle width direction toward the downstream of the air flow. Therefore, since the air flow can be delivered in a wide range, the comfort of the occupant on the rear seat is improved. Further, the bending effect of the air flow by the horizontal adjustment louvers 71a, 71b, 71c, and 71d and the bending effect of the air flow by the downstream wall surfaces 236 and 238 are created.

### Other Embodiments

(1) In the first to third embodiments, the example in which the seat air conditioning unit 20 uses the air conditioning wind, which is blown out from the interior air conditioning unit 10 provided inside of the instrument panel 2 in the foremost portion of the vehicle interior has been described. However, the present disclosure is not limited to the above example, and may be configured as follows. In other words, the interior air conditioning unit 10 for supplying the air conditioning wind to the seat air conditioning unit 20 may be configured with any interior air conditioning unit provided at any position as long as the position is outside of the seat in the vehicle interior.

For example, the seat air conditioning unit 20 may use the air conditioning wind, which is blown out from the interior air conditioning unit 10 provided on a ceiling side in the vehicle interior. The seat air conditioning unit 20 may use the air conditioning wind, which is blown out from the interior air conditioning unit 10 provided on the rear side in the vehicle traveling direction in the vehicle interior. The seat air conditioning unit 20 may use the air conditioning wind, which is blown out from the interior air conditioning unit 10 provided in the vehicle width direction in the vehicle interior.

(2) The seats having the multiple seating surface blowing ports and the rear seat face blowing port 25 are not limited to the seat on the frontmost side in the vehicle interior. Any seat may be used as the seat provided with the multiple seating surface blowing ports and the rear seat face blowing port 25 as long as the seat has the rear seat on the rear side of the seat in the vehicle traveling direction. For example, the multiple seating surface blowing ports and the rear seat face blowing port 25 may be provided in a seat of a second row of a three row seat.

(3) In the above first to third embodiments, the example in which the rear seat face blowing port 25 is provided in a portion facing the occupant on the rear seat in the back surface of the front seat 3 has been described. However, the present disclosure is not limited to the above example, and the rear seat face blowing port 25 may be provided at a position deviated from the portion facing the occupant on the rear seat as long as the portion is the back surface of the front seat 3.

(4) In the above first to third embodiments, the example in which when the occupant is present on the front seat 3 and the occupant is present on the rear seat, the air conditioning wind of the equivalent air volume is blown out from the interior air conditioning unit 10 to the rear seat foot duct 50 and the seat air conditioning duct 21 is described. However, the present disclosure is not limited to the above configuration but may be configured as follows.

In other words, the volume of air flowing into the rear seat foot duct 50 from the interior air conditioning unit 10 may be set to be different from the volume of air flowing into the seat air conditioning duct 21 from the interior air conditioning unit 10.

(5) In the above first to third embodiments, the example in which the determination in Steps S100, S110, and S120 is implemented based on the output signal of the operation unit 41 has been described, but the present disclosure is not limited to this example. In other words, a seating sensor for determining whether the occupant is seated for each seat, or not, is installed in each seat in the vehicle interior, and the determinations in Steps S100, S110, and S120 may be implemented based on a detection signal of the seating sensor for each seat.

(6) Any type of vehicle to which the seat air conditioning unit 20 according to the present disclosure is applied may be used. The seat air conditioning unit 20 according to the present disclosure can be applied to various types of automobiles.

(7) The vertical adjustment louvers 61a, 61b and the vertical adjustment shafts 62a, 62b according to the fourth and sixth embodiments may be additionally provided in a portion surrounded by the rear seat face blowing port 25 in the back air passage 23a of the seventh and eighth embodiments. In this case, the vertical adjustment louvers 61a and 61b are controlled in posture as in the fourth, sixth and seventh embodiments.

In addition, the horizontal adjustment louvers 71a, 71b, 71c, 71d and the horizontal adjustment shafts 72a, 72b, 72c, and 72d according to the seventh and eighth embodiments may be additionally provided in a portion surrounded by the rear seat face blowing port 25 in the back air passage 23a of the fourth, fifth, and sixth embodiments. In this case, the horizontal adjustment louvers 71a, 71b, 71c, and 71d are controlled in posture as in the seventh and eighth embodiments.

With the above configuration, the air flow can be bent in both of the vehicle vertical direction and the vehicle width direction.

(8) The shapes of the upstream wall surface 231 and the downstream wall surface 232 according to the fifth embodiment may be applied to the lower wall surface of the inner wall surface of the rear seat face blowing port 25 according to the fourth, seventh, and eighth embodiments.

In addition, the shapes of the upstream wall surfaces 231, 233 and the downstream wall surfaces 232, 234 according to the sixth embodiment may be applied to the upper and lower wall surfaces of the inner wall surfaces of the rear seat face blowing port 25 according to the fifth, seventh, and eighth embodiments.

In addition, the shapes of the upstream wall surfaces 235, 237 and the downstream wall surfaces 236, 238 according to the eighth embodiment may be applied to the right and left wall surfaces of the inner wall surfaces of the rear seat face blowing port 25 according to the fourth, fifth, and sixth embodiments.

With the above configuration, the air flow can be bent in both of the vehicle vertical direction and the vehicle width direction.

(9) In the fourth to eighth embodiments, the air flow passing through the rear seat face blowing port 25 is bent in one or both of the vehicle vertical direction and the vehicle width direction. However, the direction in which the airflow is bent may not necessarily be limited to the above directions. For example, the louvers or the inner wall surface of the rear seat face blowing port 25 may be configured such that the air flow passing through the rear seat face blowing port 25 is bent in an oblique direction (for example, the lower right direction of the vehicle, the upper right direction of the vehicle) between the vehicle vertical direction and the vehicle width direction.

Meanwhile, the present disclosure is not limited to the above-mentioned embodiments, and may be appropriately modified. The above-described embodiments are not irrelevant with each other, and can be appropriately combined with each other except when the combination is obviously unavailable. In the above-described respective embodiments, elements configuring the embodiments are not necessarily indispensable as a matter of course, except when the elements are particularly specified as indispensable and the elements are considered as obviously indispensable in principle. In the above-described respective embodiments, when numerical values such as the number, figures, quantity, a range of configuration elements in the embodiments are described, the numerical values are not limited to a specific number, except when the elements are particularly specified as indispensable and the numerical values are obviously limited to the specific number in principle. In the above-described respective embodiments, when a shape, a positional relationship, and the like of a configuration element and the like are mentioned, the shape, the positional relationship, and the like are not limited thereto excluding a particularly stated case and a case of being limited to specific shape, positional relationship, and the like based on the principle.

Step S101 in the above embodiment corresponds to a first control unit, Step S111 corresponds to a second control unit, Step S101A corresponds to a third control unit, and Step S111A corresponds to a fourth control unit.

What is claimed is:

1. A vehicle seat air conditioning unit for use in an automobile having an interior air conditioning unit provided outside of a seat in a vehicle interior to blow an air conditioning wind, the vehicle seat air conditioning unit comprising:
a plurality of seating surface blowing ports opening in a seating surface of the seat on which an occupant can be seated;
a first rear seat blowing port provided on a rear side of the seat in a vehicle traveling direction and opens toward a rear seat, which is provided on the rear side of the seat in the vehicle traveling direction; and
a single first duct provided between the plurality of seating surface blowing ports, the first rear seat blowing port and the interior air conditioning unit, and guides the air conditioning wind from the interior air conditioning unit to the plurality of seating surface blowing ports and the first rear seat blowing port, wherein
the plurality of seating surface blowing ports and the first rear seat blowing port blow out the air conditioning wind, which flows from the interior air conditioning unit through the first duct, into a vehicle interior.

2. The vehicle seat air conditioning unit according to claim 1, wherein
the interior air conditioning unit is provided inside of an instrument panel in the vehicle interior, and
the single first duct is provided to extend from an inside of the instrument panel toward the seat.

3. The vehicle seat air conditioning unit according to claim 1, further comprising:
a first air volume adjusting valve that regulates a ratio of a volume of air, which flows toward the plurality of seating surface blowing ports, to a volume of air, which flows toward the first rear seat blowing port, among the air conditioning wind flowing from the interior air conditioning unit through the first duct;
a first control unit that controls the first air volume adjusting valve to increase the volume of air, which flows toward the plurality of seating surface blowing ports, among the air conditioning wind flowing in the first duct more than the volume of air, which flows toward the first rear seat blowing port, when it is determined that an occupant is present on the seat and no occupant is present on the rear seat; and
a second control unit that controls the first air volume adjusting valve to increase the volume of air, which flows toward the first rear seat blowing port, more than the volume of air, which flows toward the plurality of seating surface blowing ports, among the air conditioning wind flowing in the first duct when it is determined that no occupant is present on the seat and the occupant is present on the rear seat.

4. The vehicle seat air conditioning unit according to claim 1, further comprising:
a first air volume adjusting valve that regulates a ratio of the volume of air, which flows toward the plurality of seating surface blowing ports, to the volume of air, which flows toward the first rear seat blowing port, among the air conditioning wind flowing from the interior air conditioning unit through the first duct; and
a first control unit that controls the first air volume adjusting valve to increase the volume of air, which flows toward the plurality of seating surface blowing ports, more than the volume of air, which flows toward the first rear seat blowing port, among the air conditioning wind flowing in the first duct, when it is determined that no occupant is present on the rear seat.

5. The vehicle seat air conditioning unit according to claim 1, further comprising:
a second rear seat blowing port provided independently from the first rear seat blowing port and opens toward a rear seat; and
a second duct provided independently from the first duct and guides the air conditioning wind, which is blown from the interior air conditioning unit to the second rear seat blowing port.

6. The vehicle seat air conditioning unit according to claim 5, further comprising:
a second air volume adjusting valve that regulates a ratio of the volume of air, which flows from the interior air conditioning unit into the first duct, to the volume of air, which flows from the interior air conditioning unit into the second duct;
a third control unit that controls the second air volume adjusting valve to increase the volume of air, which flows from the interior air conditioning unit into the first duct, more than the volume of air, which flows from the interior air conditioning unit into the second duct, when it is determined that the occupant is present on the seat and no occupant is present on the rear seat; and
a fourth control unit that controls the second air volume adjusting valve to increase the volume of air, which flows from the interior air conditioning unit into the second duct, more than the volume of air, which flows from the interior air conditioning unit into the first duct, when it is determined that no occupant is present on the seat and the occupant is present on the rear seat.

7. The vehicle seat air conditioning unit according to claim 5, wherein
the first rear seat blowing port is a face blowing port for blowing out the air conditioning wind to an upper body of the occupant on the rear seat, and
the second rear seat blowing port is a foot blowing port for blowing out the air conditioning wind to a lower body of the occupant on the rear seat.

8. The vehicle seat air conditioning unit according to claim 1, wherein
the seat is a left front seat in the vehicle,
the plurality of seating surface blowing ports are a plurality of left seating surface blowing ports,
the first rear seat blowing port is a left rear seat blowing port,
the duct is a left duct,
the vehicle seat air conditioning unit includes:
a plurality of right seating surface blowing ports opening in a seating surface on which the occupant is seated in a right front seat located on a right side of the left front seat in the vehicle;
a right rear blowing port provided on a rear side of the right front seat in the vehicle traveling direction and opens toward a rear seat, which is provided on the rear side in the vehicle traveling direction with respect to the right front seat; and
a single right duct provided between the plurality of right seating surface blowing ports and the right rear seat blowing port and the interior air conditioning unit to guide the air conditioning wind from the interior air conditioning unit to the plurality of right seating surface blowing ports and the right rear seat blowing port,
the plurality of right seating surface blowing ports and the right rear seat blowing port blows out blow out the air conditioning wind, which flows from the interior air conditioning unit through the right side duct, into the vehicle interior, and
a volume of air blown out from the plurality of left seating surface blowing ports, a volume of air blown out from the left rear seat blowing port, a volume of air blown out from the plurality of right seating surface blowing ports, and a volume of air blown out from the right rear seat blowing port are controlled independently from each other.

9.-16. (canceled)
